(19) United States
(12) Patent Application Publication
(10) Pub. No.: US 2021/0342115 A1
(43) Pub. Date: Nov. 4, 2021

(54) DATA PROCESSING SYSTEMS FOR PROVIDING A DATA COMMUNICATION CHANNEL BETWEEN ONE OR MORE CONNECTED COMPUTING DEVICES AND AN INTERACTIVE DISPLAY

(71) Applicant: Promethean Limited, Blackburn (GB)

(72) Inventors: Paul Wareing, Catterall (GB); Ben Titterington, Preston (GB); Andrew Edwardson, Whalley (GB)

(73) Assignee: Promethean Limited, Blackburn (GB)

(21) Appl. No.: 17/245,035

(22) Filed: Apr. 30, 2021

Related U.S. Application Data
(60) Provisional application No. 63/018,800, filed on May 1, 2020.

(51) Int. Cl. G06F 3/14; G06F 13/38

(52) U.S. Cl. CPC G06F 3/1454; G06F 3/1415; G06F 2213/0042; G06F 13/385; G06F 3/1423

(57) ABSTRACT

An Interactive Display System may be configured to enable and facilitate a permanent communications pathway between a display device and each of a plurality of connected computing devices. In particular embodiments, the permanent communication channel is configured to transmit data between each connected computing device and the display device. In particular embodiments, the permanent communications path is facilitated via one or more USB relays. Each USB Relay may be configured to enable a direct connection between each connected computing device and the display device, where both the connected computing device and the display device are configured as USB Hosts. In particular embodiments, the USB Relay is configured as a USB device to each connected computing device and the display device and further configured to pass-through data received at the USB Relay (e.g., as a USB device) to the opposite USB Host.

### BACKGROUND

Users of interactive displays or other display devices may desire a streamlined, unified experience, particularly when utilizing one or more connected devices through a single display. Accordingly, there is a need for systems and methods that address these desires.

### SUMMARY

An interactive display system, in particular embodiments, is configured for causing an interactive display device to display one or more pieces of data received from one or more connected computing devices. In any embodiment described herein, the interactive display system may comprise a display device controller configured to be operatively coupled to the interactive display device and each of the one or more connected computing devices. In particular embodiments, the display device controller comprises one or more display device controller processors. In various embodiments, the one or more display device controller processors are configured as a first USB host device; and the display device controller is configured for: (1) receiving, from a first connected computing device of the one or more connected computing devices, the one or more pieces of data, wherein the first connected computing device is configured as a second USB host device; (2) receiving the one or more pieces of data from the first connected computing device via a communications channel between the first USB host device and the second USB host device; (3) generating, by the one or more display device controller processors, an on-screen display based at least in part on the one or more pieces of data; (4) causing, by the one or more display device controller processors, the interactive display device to display one or more incoming images from a second connected computing device of the one or more connected computing devices; and (4) causing, by the one or more display device controller processors, the interactive display device to display the on-screen display along with the one or more incoming images from the second connected computing device. In particular embodiments, the interactive display device comprises the display device controller.

In particular embodiments of an interactive display system, the one or more pieces of data comprise a substantially current (e.g., current, live, up-to-date, etc.) preview of a video output from the first connected computing device. In still other embodiments of the interactive display system, generating, by the one or more display device controller processors, the on-screen display based at least in part on the one or more pieces of data comprises generating the on-screen display to include the substantially current preview of the video output from the first connected computing device. In any embodiment described herein, the one or more pieces of data comprise software data associated with a piece of software currently running on the first connected computing device; and generating, by the one or more display device controller processors, the on-screen display based at least in part on the one or more pieces of data comprises generating the on-screen display to include the piece of software (e.g., a link, icon, or other indicia for launching the piece of software). In various embodiments, the piece of software may include, for example, a timer application and/or an annotation application.

In any embodiment described herein of an interactive display system, the display controller may further comprise one or more USB relays, each of the one or more USB Relays being configured as a USB device to both the one or more display device controller processors and each of the one or more connected computing devices; and the interactive display system may be configured for receiving, via the communications channel, the one or more pieces of data at the one or more USB relays configured as the USB device to the first USB host device from the second USB host device. In various other embodiments of an interactive display system, the display controller is configured to operatively couple to the second connected computing device via a first video connection; and causing, by the one or more display device controller processors, the interactive display device to display the one or more incoming images from the second connected computing device comprises selecting, by the one or more display device controller processors, the first video connection as a video input for the interactive display device.

In particular embodiments of the interactive display system: (1) the integrated display system is further configured for identifying, based at least in part on the one or more pieces of data, a device ID associated with the first connected computing device; and generating, by the one or more display device controller processors, the on-screen display based at least in part on the one or more pieces of data comprises: (1) retrieving one or more user preferences associated with the device ID; and (2) generating the on-screen display based at least in part on the one or more user preferences. In various embodiments, generating the on-screen display based at least in part on the one or more user preferences comprises determining one or more contents of at least one user interface displayed within the on-screen display based at least in part on the one or more user preferences.

A computer-implemented data processing method of modifying an on-screen display of an interactive display device that is operatively coupled to a display controller to include one or more first images from a first connected computing device while the interactive display device is displaying one or more incoming images from a second connected computing device, the second connected computing device being the currently selected video source for the interactive display device, in various embodiments, comprises: (1) configuring, by one or more computer processors, the first connected computing device as a first USB host device; (2) configuring, by the one or more computer processors, a display controller device as a second USB host device; (3) providing, by the one or more computer processors, a data communication channel between the first USB host device and the second USB host device; (4) receiving, by the one or more computer processors, via a data communication channel between the first USB host device and the second USB host device, one or more pieces of data from the first connected computing device; (5) generating, by the one or more computer processors, an on-screen display based at least in part on the one or more pieces of data; (6) causing, by the one or more computer processors, the interactive display device to display the one or more incoming images from the second connected computing device; and (7) causing, by the one or more computer processors, the interactive display device to superimpose the generated on-screen display over at least a portion of the one or more incoming images from the second connected computing device.

In various embodiments, the one or more pieces of data comprise software data associated with a piece of software currently running on the first connected computing device; and generating, by the one or more computer processors, the on-screen display based at least in part on the one or more pieces of data comprises generating the on-screen display to include a visual representation of the piece of software. In particular embodiments, the method further comprises: (1) receiving, by the one or more computer processors, an input on the interactive display device; (2) determining, by the one or more computer processors, a location of the input; (3) determining that the input location comprises the visual representation of the piece of software on the on-screen display; and (4) in response to determining that the input location comprises the visual representation of the piece of software on the on-screen display, transmitting the input location to the first connected computing device via the data communication channel.

In still other embodiments, the method further comprises determining, based at least in part on the one or more pieces of data, a device ID associated with the first connected computing device. In particular embodiments, generating, by the one or more computer processors, the on-screen display based at least in part on the one or more pieces of data comprises: (1) retrieving one or more user preferences associated with the device ID; and (2) generating the on-screen display based at least in part on the one or more user preferences. In still other embodiments, generating the on-screen display based at least in part on the one or more user preferences comprises determining and applying at least one device setting for the interactive display device based at least in part on the one or more user preferences. In particular embodiments, the one or more pieces of data comprise a substantially current preview of a video output from the first connected computing device; and generating, by the one or more display device processors, the on-screen display based at least in part on the one or more pieces of data comprises generating the on-screen display to include the substantially current preview of the video output from the first connected computing device.

In any embodiment described herein, the data-processing method may comprise: (1) configuring, by one or more computer processors, the second connected computing device as a third USB host device; (2) providing, by one or more computer processors, a second data communication channel between the second USB host device and the third USB host device; (3) determining, by one or more computer processors, that the one or more pieces of data include one or more pieces of data for the second connected computing device; and (4) in response to determining that the one or more pieces of data include the one or more pieces of data for the second connected computing device, transmitting, by one or more processors, the one or more pieces of data for the second connected computing device from the display controller to the second connected computing device via the second data communication channel. In various embodiments, providing the data communication channel between the first USB host device and the second USB host device comprises providing the data communication channel via a USB relay configured as a USB device to both the first USB host device and the second USB host device

An interactive display system for integrating one or more pieces of data received from one or more connected computing devices into an onscreen display of an interactive display device operatively coupled to each of the one or more connected computing devices, in particular embodiments, comprises and interactive display device comprising: (1) one or more interactive display device processors; (2) one or more touch-enabled input devices; and (3) one or more USB relays, each of the one or more USB relays being operatively connected to the one or more interactive display device processors, wherein the one or more USB relays comprise a first USB relay. In particular embodiments, (1) a first connected computing device of the one or more connected computing devices is configured as a first USB host device; (2) the one or more interactive display device processors are configured as a second USB host device; and (3) the first USB relay is configured as a USB device to the both the first USB host and the second USB host and configured to form a communications channel between the first connected computing device and the one or more interactive display device processors.

In any embodiment described herein, the interactive display system may be configured for: (1) receiving, via the communications channel, one or more pieces of data at the first USB relay acting as the USB device to the first USB host from the first connected computing device; and (2) passing, via the communications channel, by the first USB relay acting as the USB device to the second USB host, the received one or more pieces of data from the first USB relay through to the one or more interactive display device processors; (3) generating, by the one or more interactive display device processors, an on-screen display based at least in part on the one or more pieces of data; (4) causing, by the one or more interactive display device processors, the interactive display device to display one or more incoming images from a second connected computing device of the one or more connected computing devices; and (5) causing, by the one or more interactive display device processors, the interactive display device to display the generated on-screen display along with the one or more incoming images from the second connected computing device. In particular embodiments, causing, by the one or more interactive display device processors, the interactive display device to display the one or more incoming images from the second connected computing device of the one or more connected computing devices comprises causing the interactive display device to select the second connected computing device as a video source for the interactive display device.

### BRIEF DESCRIPTION OF THE DRAWINGS

Various embodiments of an interactive display system are described below. In the course of this description, reference will be made to the accompanying drawings, which are not necessarily drawn to scale, and wherein:

FIG. 1 is a block diagram of an interactive display system in accordance with an embodiment of the present system;

FIG. 2 is a block diagram of an interactive display system in accordance with a particular embodiment of the present system;

FIG. 3 is a block diagram of an interactive display system in accordance with yet another embodiment of the present system;

FIG. 4 is a schematic diagram of a computer, such as the one or more interactive display devices or the One or More Connected Computing Devices 112 of FIG. 1, that is suitable for use in various embodiments;

FIG. 5 depicts a schematic diagram of a USB topology of an interactive display system according to a particular embodiment;

FIG. 6 depicts a schematic diagram of a USB Relay according to a particular embodiment;

FIG. 7 depicts a schematic diagram of a USB Relay according to yet another embodiment;

FIGS. 8-10 depict schematic diagrams of USB topologies of an interactive display system according to various embodiments;

FIG. 11 depicts a flow chart that illustrates various steps executed by a particular embodiment of a USB Host to USB Host Transfer Module 1100 that may, for example, be executed by the Interactive Display Controller Device 120 of FIG. 1;

FIG. 12 depicts a flow chart that illustrates various steps executed by a particular embodiment of a Connected Device Discovery and Configuration Module 1200 that may, for example, be executed by the Interactive Display Controller Device 120 of FIG. 1;

FIG. 13 depicts a flow chart that illustrates various steps executed by a particular embodiment of an On-Screen Display Generation and Modification Module 1300 that may, for example, be executed by the Interactive Display Controller Device 120 of FIG. 1; and

FIGS. 14-16 depict exemplary screen displays and graphical user interfaces (GUIs) according to various embodiments of the system, which a user may encounter when utilizing various embodiments of an interactive display system described herein.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

An Interactive Display System 100, according to particular embodiments, comprises: (1) One or More Interactive Display Devices 110, which may, for example, include any suitable interactive display device (e.g., such as any suitable Promethean ActivPanel display); and (2) One or More Connected Computing Devices 112 operatively coupled to the One or More Interactive Display Devices 110 (e.g., via any suitable connection). In some embodiments, the One or More Interactive Display Devices 110 are configured to display data (e.g., video data, image data, etc.) from the One or More Connected Computing Devices 112 on at least a portion of a display screen of the One or More Interactive Display Devices 110. In various embodiments the data displayed on the Interactive Display Device 110 from the One or More Connected Computing Devices 112 is passed via one or more intermediate devices (e.g., via the Interactive Display Controller Device 120). In particular embodiments, the One or More Interactive Display Devices 110 are configured to pass one or more inputs received at the One or More Interactive Display Devices 110 to the One or More Connected Computing Devices 112 (e.g., via the Interactive Display Controller Device 120).

In particular embodiments, the Interactive Display System 110 comprises an Interactive Display Controller Device 120 configured to receive data from the One or More Connected Computing Devices 112 for display on the Interactive Display Device 110. The Interactive Display Controller Device 120, may, for example, be configured to: (1) receive video, audio, and other data from at least one of the One or More Connected Computing Devices 112; (2) transfer the video, audio, and other data to the Interactive Display Device 110 for display on the Interactive Display Device 110 (e.g., via a suitable connection, cable, etc.); (3) generate an On-Screen Display for display on the Interactive Display Device 110 (e.g., based on data received from any of the One or More Connected Computing Devices 112; (4) receive input data (e.g., touch input data) from the Interactive Display Device 110, and transmit the input data to at least one of the One or More Connected Computing Devices 112 (e.g., determine which of the One or More Connected Computing Devices 112 is the target connected computing device for the touch input, and transmit the touch input to the appropriate determined device).

In particular embodiments, the Interactive Display Device 110 comprises the Interactive Display Controller Device 120. In various embodiments, the Interactive Display Device 110 is configured to display one or more incoming images from a particular Connected Computing Device (e.g., Connected Computing Device A 112A). In such embodiments, the interactive computing device 110 is configured to display the one or more incoming images from a particular Connected Computing Device that is the currently selected video source for the Interactive Display Device 110 (e.g., or the currently selected video source for the Interactive Display Controller Device 120). In various embodiments, the Interactive Display Controller Device 120 is further configured to cause the Interactive Display Device 110 to superimpose an on-screen display over the one or more incoming images from the particular Connected Computing Device. In particular embodiments, the Interactive Display Controller Device 120 is configured to generate the on-screen display based at least in part on one or more pieces of data received from the one or more connected computing devices (i.e., at least one connected computing device other than the particular computing device that is currently the selected video source for the Interactive Display Device 110 and/or Interactive Display Controller Device 120).

In particular embodiments, an Interactive Display Device 110 may include any suitable display device having a display screen and one or more input devices. In various embodiments, each of the One of More Connected Computing Devices 112 may be operatively connected to the Interactive Display Device 110 via both a suitable video connection (e.g., such that the interactive display device can display one or more images from the one or more connected computing devices) and a suitable data connection (e.g., such that the Interactive Display Device 110 can transmit one or more user inputs received via the one or more input devices to at least one of the one or more connected computing devices). In a particular embodiment, the suitable video connection may include any suitable connection and/or cable such as, for example: one or more composite video cable(s), s-video cable(s), component video cable(s), VGA cable(s), DVI cable(s), HDMI cable(s), DisplayPort cable(s), mini-DisplayPort cable(s), USB-C cable(s) or any suitable combination thereof. In any embodiment described herein, the suitable data connection may include, for example: one or more ethernet cable(s), token ring cable(s), coaxial cable(s), optical fiber cable(s), USB cable(s), etc. In a particular example, each of the One or More Connected Computing Devices 112 may be operatively connected to the Interactive Display Device 110 via both an HDMI cable (e.g., in order to facilitate one or more images from the connected computing device to the interactive display device) and a USB cable (in order to transmit touch input data from the interactive display device to the connected computing device).

In some embodiments, each of the One or More Connected Computing Devices 112 may be operatively connected to the Interactive Display Device 110 via the Interactive Display Controller Device 120. In such embodiments, each of the One or More Connected Computing Devices 112 may be operatively connected to the Interactive Display Controller Device 120 (e.g., via both a suitable video and data connection), and the Interactive Display Controller Device 120 may, in turn, be operatively connected to the Interactive Display Device 110 (e.g., via both a suitable video and data connection).

In particular embodiments, as may be understood by one skilled in the art, a typical Interactive Display Device 110 may be configured to display one or more images from only one particular Connected Computing Device of the one or more connected computing device at a particular time. In some embodiments, the interactive display device may generally be limited to selecting a single source device at a time for display on the Interactive Display Device 110. For example, an Interactive Display Device 110 may have three connected computing devices (e.g., connected computing device A, connected computing device B, and connected computing device C) connected via respective HDMI ports (e.g., HDMI port 1, port 2 and port 3 respectively). Such an Interactive Display Device 110 may, for example, select among HDMI ports 1, 2, and 3 in order to display image data from the corresponding connected computing device. When selecting HDMI port 1, the interactive display device may, for example, display image data from connected computing device A, and be unable to display or otherwise receive data from connected computing devices B or C.

A particular embodiment of an Interactive Display System 100 however, may, for example, be configured to enable and facilitate a permanent communications pathway between an Interactive Display Device 110 and each of a plurality of connected computing devices 112 (e.g., even between the Interactive Display Device 110 and each connected device that is not the currently active video source for the Interactive Display Device 110). In various embodiments, the permanent communications pathway is facilitated by the Interactive Display Controller Device 120. In particular embodiments, the Interactive Display System 100 is configured to facilitate the permanent communication pathway via an existing connection between each of the One or More Connected Computing Devices 112 and the Interactive Display Device 110. As such, various embodiments of the Interactive Display System 100 described herein may increase a functionality of an Interactive Display Device 110 without requiring: (1) a user to connect the interactive display device to any of the connected computing devices using any additional cables; (2) a user to connect any of the connected computing devices or the interactive display device to any network; (3) any of the connected computing devices to establish a wireless connection with the interactive display device; and/or (4) a user to take any additional action to operatively connect any of the connected computing devices to the interactive display beyond establishing a video and data connection (e.g., as the user would for an interactive display system that simply cycles which of the connected computing devices the interactive display device is displaying based on a selected input and provides touch input data to the selected connected computing device).

In particular embodiments, the permanent communication channel is configured to transmit data between each Connected Computing Device 112 and the Interactive Display Device 110 (e.g., via the Interactive Display Controller Device 120). In various embodiments, the data transmitted may include, for example: (1) device data; (2) software date (e.g., data regarding available software on each connected device, data regarding software currently running on each connected device which may be integrated into an on-screen display for the interactive display device, etc.); (3) preview data (e.g., such as one or more substantially current images that each connected computing device would cause the interactive display device to display if selected as the current video source; and/or (4) any other suitable data.

In particular embodiments, the permanent communications path is facilitated via one or more USB relays. As described herein, each of the One or More Connected Computing Devices 112 may utilize a USB connection to the Interactive Display Device 110 (e.g., or the Interactive Display Controller Device 120 operatively connected to the Interactive Display Device 110). In particular embodiments, the Interactive Display Controller Device 120 comprises the one or more USB Relays 120.

In various embodiments, each USB Relay 520 is configured to enable a direct connection between each Connected Computing Device 112 and the Interactive Display Device 110, where both the Connected Computing Device 112 and the Interactive Display Device 110 are configured as USB Hosts. In particular embodiments, the USB Relay (e.g., the Interactive Display Controller Device 120) is configured as a USB device to each Connected Computing Device 112 and the Interactive Display Controller Device 12 (e.g., and/or the Interactive Display Device 110, in embodiments in which the Interactive Display Device 110 comprises the Interactive Display Controller Device 120), and further configured to pass-through data received at the USB Relay (e.g., as a USB device) to the opposite USB Host (e.g., either the Connected Computing Device 112, the Interactive Display Controller Device 120, or the Interactive Display Device 110). In particular embodiments, the USB Relay makes the data received from the first USB host available to the second USB host which may be requesting the data from the USB Relay, serving as a USB device to both USB hosts. In this way, the system is configured to provide a communications channel between two USB hosts (e.g., via the Interactive Display Controller Device 120 that comprises One or More USB Relays 520), even when the Connected Computing Device 112 is not the currently selected video input (e.g., and would not otherwise be transmitting any data to the Interactive Display Device 110, particular while the interactive display device is displaying images form a different connected computing device as the selected video source).

In particular embodiments, the One or More USB Relays 520 are configured to provide a USB Host to USB Host connection between any of: (1) a particular one of the One or More Connected Computing Devices 112 and the Interactive Display Controller Device 120; (2) a particular one of the One or More Connected Computing Devices 112 and the Interactive Display Device 110; and/or any other suitable combination of USB Hosts described herein.

### Exemplary Technical Platforms

As will be appreciated by one skilled in the relevant field, the present invention may be, for example, embodied as a computer system, a method (e.g., a computer-implemented method, computer-implemented data processing method, etc.), or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium (e.g., a nontransitory computer-readable medium) having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods (e.g., computer-implemented methods), apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

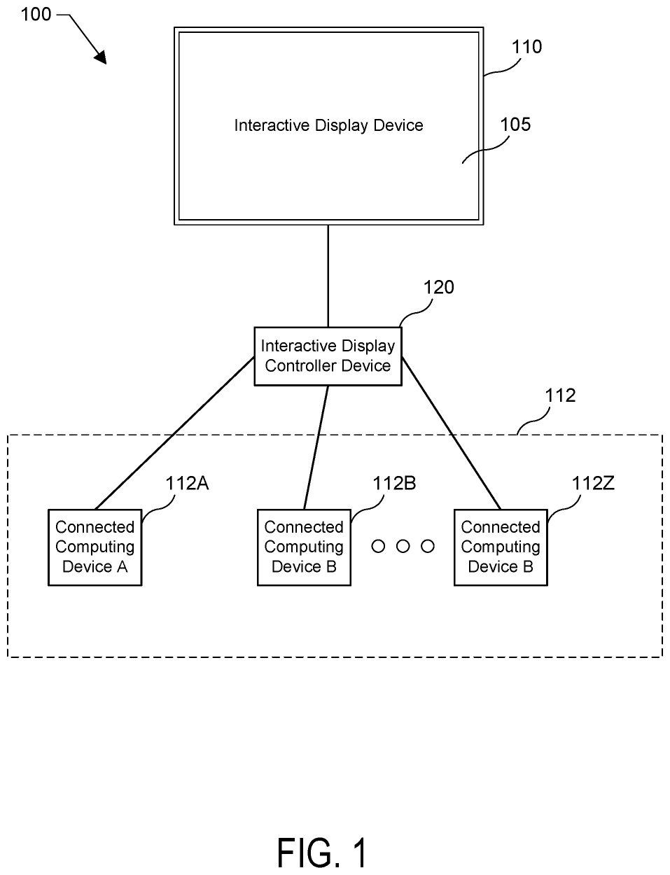

FIG. 1 is a block diagram of an Interactive Display System 100 according to a particular embodiment. As may be understood from this figure, an Interactive Display System 100, according to a particular embodiment, comprises: (1) One or More Interactive Display Devices 110 (e.g., one or more touch-screen displays, an interactive display device, etc.), which may, for example, include any suitable interactive display device (e.g., such as any suitable Promethean ActivPanel display, touchscreen display device, etc.) having at least a display screen and an input device 105 (e.g., touch input device); (2) an Interactive Display Controller Device 120 operatively coupled to the One or More Interactive Display Devices 110 (e.g., a computing device configured to receive data from One or More Connected Computing Devices 112, transmit inputs from the Interactive Display Device 110 to one or more of the One or More Connected Computing Devices 112, generate an on-screen display for display on the Interactive Display Device 110, and/or perform any other function described herein); and (3) One or More Connected Computing Devices 112 operatively coupled to the Interactive Display Controller Device 120 (e.g., via any suitable wireless and/or wired connection). In some embodiments, the One or More Interactive Display Devices 110 are configured to display data (e.g., video data, image data, etc.) and play audio data from the Interactive Display Controller Device 120 and/or the One or More Connected Computing Devices 112 on at least a portion of a display screen of the One or More Interactive Display Devices 110. In particular embodiments, the Interactive Display Controller Device 120 is configured to pass one or more inputs received at the One or More Interactive Display Devices 110 to the One or More Connected Computing Devices 112. In particular embodiments, the Interactive Display Device 110 comprises the Interactive Display Controller Device 120.

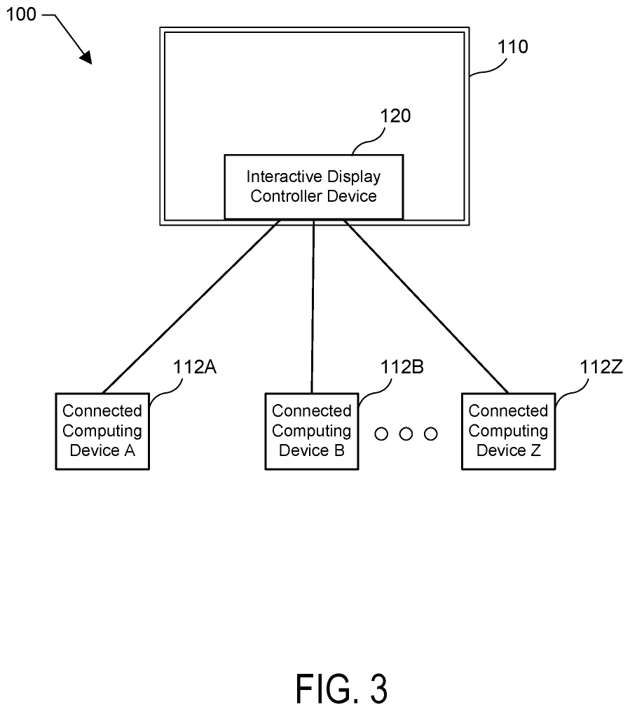

In various embodiments, the Interactive Display Controller Device 120 is embodied as a stand-alone console or other peripheral configured to be operatively coupled to the Interactive Display Device 110. In some embodiments, the Interactive Display Controller Device 120 is embodied as an Open Pluggable Specification Device (OPS). In still other embodiments the Interactive Display Device 110 comprises the Interactive Display Controller Device 120 (e.g., as shown in FIG. 3). In other embodiments, the computing device is configured to slot-in to the interactive display device (e.g., at least temporarily). In such embodiments, the computing device may be configured to be upgradable while utilizing an existing Interactive Display Device 110. In some embodiments, the Interactive Display Controller Device 120 is configured to operatively couple to any suitable interactive display device comprising a display screen and in input device 105 (e.g., touch input). As such, the Interactive Display Controller Device 120 may be embodied as an all-in-one touch-enabled display device, as an accessory for use with any existing touch-enabled display device, etc.

In particular embodiments, the Interactive Display Controller Device 120 comprises any suitable computing device (e.g., comprising at least one processor). In various embodiments, the Interactive Display Controller Device 120 is configured to facilitate one or more communications between the One or More Connected Computing Devices 112 and the Interactive Display Device 110 (e.g., as described more fully herein). In any embodiment described herein, the Interactive Display Controller Device 120 is configured to control source switching between the One or More Connected Computing Devices 112 and the Interactive Display Device 110 (e.g., such that the Interactive Display Controller Device 120 is configured to control which connected computing device of the One or More Connected Computing Devices 112 is the current video source for the Interactive Display Device 110). In still other embodiments, the Interactive Display Controller Device 120 is configured to generate (e.g., render) an on-screen display (OSD) overlay for display, by the Interactive Display Device 110, such that the on-screen display is superimposed over one or more images being displayed on the Interactive Display Device 110 that are received from the currently selected source computing device of the One or More Connected Computing Devices 112. In particular embodiments, the Interactive Display Controller Device 120 is configured to generate (e.g., render) the on-screen display (OSD) to display one or more pieces of data received from at least one of the One or More Connected Computing Devices 112 that are not the currently selected video source for the Interactive Display Device 110.

In various embodiments, the Interactive Display Controller Device 120 may be operatively coupled (e.g., connected) to the One or More Connected Computing Devices 112 in any suitable manner using any suitable connection type (e.g., wired and/or wireless connection type). For example, in particular embodiments, the Interactive Display Controller Device 120 may be operatively coupled (e.g., connected) to the One or More Connected Computing Devices 112 via any suitable video cable (e.g., composite video cable(s), s-video cable(s), component video cable(s), VGA cable(s), DVI cable(s), HDMI cable(s), DisplayPort cable(s), mini-DisplayPort cable(s), etc.) or combination thereof. In still other embodiments, the Interactive Display Controller Device 120 may be operatively coupled (e.g., connected) to the One or More Connected Computing Devices 112 via any suitable data cable (e.g., ethernet cable(s), token ring cable(s), coaxial cable(s), optical fiber cable(s), USB cable, etc.) or suitable combination thereof. In still other embodiments, the Interactive Display Controller Device 120 may be operatively coupled (e.g., connected) to the One or More Connected Computing Devices 112 via any suitable wireless connection (e.g., Bluetooth, WIFI, NFC, low energy Bluetooth, ZigBee, etc.) or combination of wireless connections. In other embodiments, the Interactive Display Controller Device 120 may be operatively coupled (e.g., connected) to the One or More Connected Computing Devices 112 via any suitable combination of connection types described herein, or in any other suitable manner.

In various embodiments, the Interactive Display Controller Device 120 may be further operatively coupled (e.g., connected) to Interactive Display Device 110 in any suitable manner using any suitable connection type (e.g., wired and/or wireless connection type). For example, in particular embodiments, the Interactive Display Controller Device 120 may be operatively coupled (e.g., connected) to the Interactive Display Device 110 via any suitable video cable (e.g., composite video cable(s), s-video cable(s), component video cable(s), VGA cable(s), DVI cable(s), HDMI cable(s), DisplayPort cable(s), mini-DisplayPort cable(s), etc.) or combination thereof. In still other embodiments, the Interactive Display Controller Device 120 may be operatively coupled (e.g., connected) to the Interactive Display Device 110 via any suitable data cable (e.g., ethernet cable(s), token ring cable(s), coaxial cable(s), optical fiber cable(s), USB cable, etc.) or suitable combination thereof. In still other embodiments, the Interactive Display Controller Device 120 may be operatively coupled (e.g., connected) to the Interactive Display Device 110 via any suitable wireless connection (e.g., Bluetooth, WIFI, NFC, low energy Bluetooth, ZigBee, etc.) or combination of wireless connections. In other embodiments, the One or More Interactive Display Devices 110 may be operatively coupled (e.g., connected) to the Interactive Display Controller Device 120 via any suitable combination of connection types described herein, or in any other suitable manner.

In a particular embodiment, each of the One or More Connected Computing Devices 112 are operatively coupled to the Interactive Display Controller Device 120 via both a suitable video and suitable data connection. In such embodiments, the suitable video connection may comprise an HDMI connection. In some embodiments, the suitable data connection may comprise any suitable USB connection. In various embodiments, the USB connection (e.g., and any USB connection described herein) may include the use of any suitable USB cable having any suitable type of connecter (e.g., USB-A, USB-B, Mini-USB, Micro-USB, USB-C, etc.). In particular embodiments, any of the one or more USB connections described herein may utilize any suitable speed standard, such as, for example: USB 1.x, USB 2.0, USB 3.x, etc.).

In various embodiments of an Interactive Display System 100, the One or More Interactive Display Devices 110 comprise one or more touch screen display devices, which may, for example, comprise any suitable touch screen device configured to receive input via contact on the display device (e.g., via a user's finger or other body part, via a stylus or other pen-like device, etc.). In such embodiments, the One or More Interactive Display Devices 110 may comprise any suitable Interactive Display Input Device 105. For example, in various embodiments, the One or More Interactive Display Devices 110 comprise one or more resistive touch screen displays (e.g., one or more 5-wire resistive touch screen displays), one or more surface capacitive touch screen displays, one or more projected capacitive touch screen displays, one or more surface acoustic wave touch screen displays, one or more infrared touch screen displays (e.g., which may, for example include one or more touch overlays at least partially embedded in a bezel of the One or More Interactive Display Devices 110), or any other suitable touch screen display. In particular embodiments, the One or More Interactive Display Devices 110 comprise one or more processors and memory. In such embodiments, the One or More Interactive Display Devices 110 may comprise stand-alone computing devices such as handheld computing device (e.g., tablet computers or smartphones), wall mounted display devices (e.g., such as touch-enabled computerized LED and/or LCD displays), etc. In other embodiments, the One or More Interactive Display Devices 110 may include any suitable ‘dumb’ interactive display device, which may, for example, primarily be configured to display information from and provide input for a at least one connected computing device (e.g., an Interactive Display Controller Device 120, one or more substantially directly Connected Computing Devices 112, One or More Connected Computing Devices 112 connected via an Interactive Display Controller Device 120, etc.). In various embodiments, the One or More Interactive Display Devices 110 comprise any suitable device comprising a display screen and an input device (e.g., Touch Input Device 105) operatively coupled to the Interactive Display Device 110.

In particular embodiments, the One or More Interactive Display Devices 110 are configured to detect a plurality of simultaneous inputs (e.g., from a plurality of users). In various embodiments, the One or More Interactive Display Devices 110 are configured to enable a user to interact with one or more displayed images as the user would interact with any other computing display device (e.g., by drawing on the one or more projected images, operating a browser, playing a video, etc.), etc. In still other embodiments, the One or More Interactive Display Devices 110 include one or more computing components (e.g., one or more processors and memory) such that the One or More Interactive Display Devices 110 each embody a stand-alone computing device (which may, for example, include the ‘black box’ Interactive Display Controller Device 120 described herein).

In particular embodiments, the One or More Interactive Display Devices 110 are configured to run software locally on the One or More Interactive Display Devices 110. For example, in one embodiment of an Interactive Display System 100, the One or More Interactive Display Devices 110 may store software applications on local memory associated with the One or More Interactive Display Devices 110 (e.g., in embodiments in which the Interactive Display Device 110 comprises the Interactive Display Controller Device 120). In particular embodiments, the software applications native to the one or more interactive display devices (e.g., or installed on the Interactive Display Controller Device 120 which may be operatively coupled to and utilized by the Interactive Display Device 110) may include, for example, any suitable software such as: (1) one or more word processing applications; (2) one or more pieces of annotation software; (3) one or more video applications; (4) one or more whiteboard simulating software applications; and/or (5) any other suitable software application.

In particular embodiments, the One or More Connected Computing Devices 112 may include any suitable connected computing device such as, for example, one or more laptop computers, one or more tablet computers, one or more Chrome boxes, one or more Amazon Fire TV devices, one or more Apple TV devices, one or more gaming systems (e.g., one or more Microsoft, Sony, Nintendo, etc. gaming systems), or any other suitable computing and/or video playing device, which may, for example, have one or more pieces of software installed thereon.

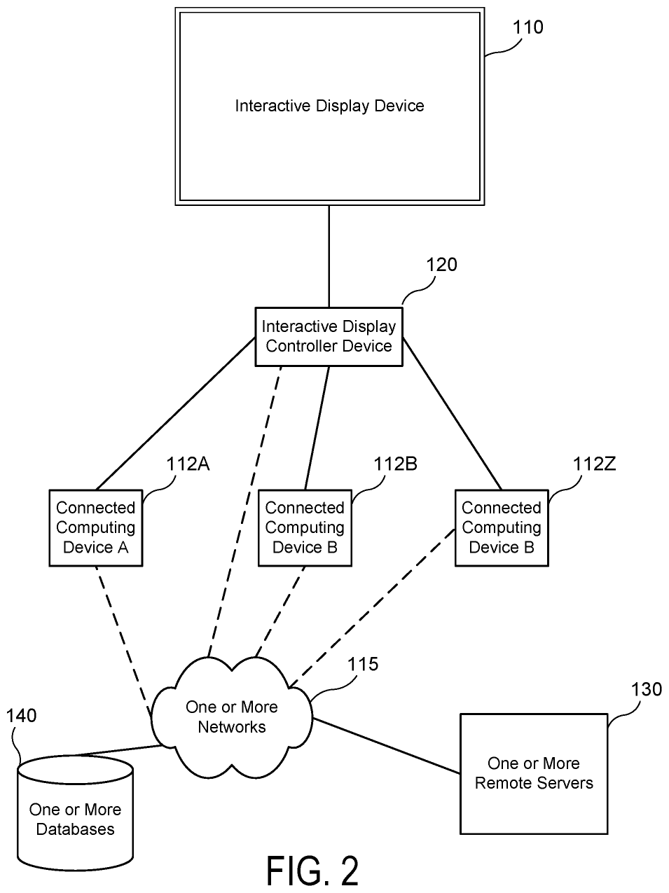

In various embodiments, the Interactive Display Device 110 is configured to operate independent of any external network and/or networks. In various other embodiments, as shown in FIG. 2, the Interactive Display Controller Device 120 and/or any of the One or More Connected Computing Devices 112 may be operatively connected to One or More Databases 140 and/or One or More Remote Servers 130 via One or More Networks 115. In such embodiments, the One or More Computer Networks 115 may facilitate communication between the Interactive Display Controller Device 110 (e.g., Interactive Display Device 110), One or More Remote Servers 130, One or More Databases 140, One or More Connected Computing Devices 112, etc. For example, the One or More Networks 115 may facilitate communication between the Interactive Display Controller Device 120 and the One or More Remote Servers 130 in order to access profile data for a device being connected to the Interactive Display Device 110 to customize a user experience for the user that connected the device while using the One or More Interactive Display Devices 110.

The One or More Networks 115 may further facilitate access between the Interactive Display Controller Device 120 and a suitable document stored in One or More Remote Databases 140 (e.g., stored in one or more remote databases managed by a third-party cloud-based storage service such as Google Drive, Dropbox, or any other suitable service). The One or More Computer Networks 115 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computers). The communication link between the computing device, the One or More Databases 140, and the One or More Remote servers 130 may be, for example, implemented via a Local Area Network (LAN) or via the Internet.

FIG. 3 depicts an embodiment in which the Interactive Display Device 110 comprises the Interactive Display Controller Device 120. For example, in particular embodiments, the Interactive Display Controller Device 120 may be integrally formed with the Interactive Display Device 110. In still other embodiments, the Interactive Display Controller Device 120 may be configured to slot into or otherwise at least temporarily engage with and operatively couple to the Interactive Display Device 110. In such embodiments, the Interactive Display Controller Device 120 may be replaceable (e.g., substantially easily replaceable) by removing the Interactive Display Controller Device 120 from the Interactive Display Device 110 and replacing Interactive Display Controller Device 120 with an updated one. In this way, the Interactive Display System 100 may be configured to enable a user to upgrade the Interactive Display Controller Device 120 while continuing to use an existing Interactive Display Device 110 (e.g., display screen and Input Device 105), which may, for example, reduce a cost associated with upgrading the Interactive Display System 100.

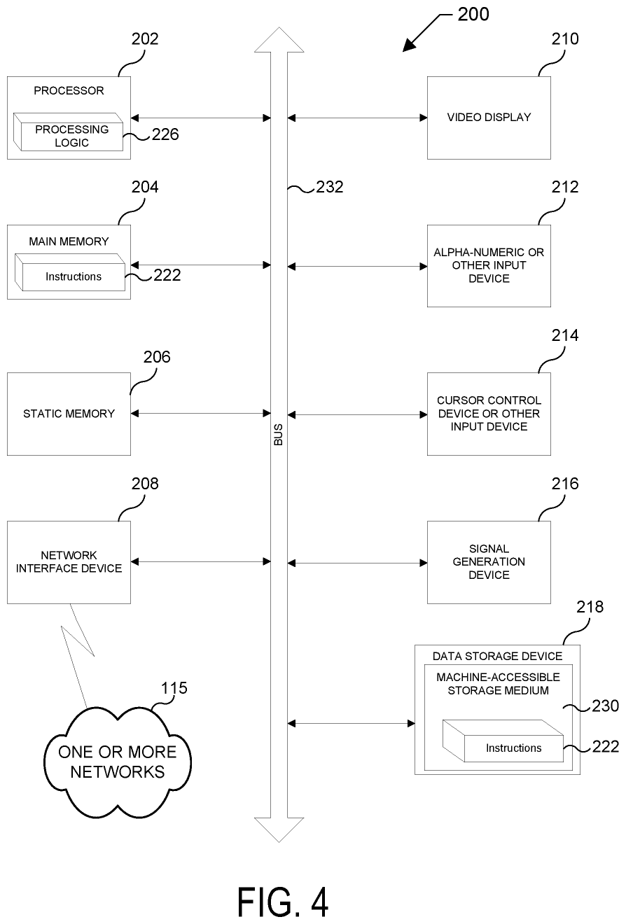

FIG. 4 illustrates a diagrammatic representation of a Computer Architecture 200 that can be used within the Interactive Display System 100, for example, as a client computer (e.g., One or More Interactive Controller Devices 120 shown in FIG. 1), or any of the One or More Connected Computing Devices 112 (e.g., such as Connected Computing Device A 112A, Connected Computing Device B 112B, etc.). In particular embodiments, the Computer 200 may be suitable for use as a computer within the context of the Interactive Display System 100 that is configured to receive input from an interactive display device (e.g., such as the One or More Interactive Display Devices 110, etc.), determine whether the input is intended for the One or More Interactive Display Devices 110 or for the One or More Connected Computing Devices 112, and passing the input through to the proper computing device for processing. In still other embodiments, the Computer 200 may be suitable for use as a computer within the context of the Interactive Display System 100 (e.g., the Interactive Display Controller Device 12) that is configured to generate an on-screen display for display on the Interactive Display Device 110 using data received from each of One or More Connected Computing Devices 112.

In particular embodiments, the Computer 200 may be connected (e.g., networked) to other computers in a LAN, an intranet, an extranet, and/or the Internet. As noted above, the Computer 200 may operate in the capacity of a server or a client computer in a client-server network environment, or as a peer computer in a peer-to-peer (or distributed) network environment. The Computer 200 may be a desktop personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary Computer 200 includes a Processing Device 202 (e.g., one or more computer processors), a Main Memory 204 (e.g., read-only memory (ROM), flash memory, dynamic random access memory (DRAM) such as synchronous DRAM (SDRAM) or Rambus DRAM (RDRAM), etc.), a Static Memory 206 (e.g., flash memory, static random access memory (SRAM), etc.), and a Data Storage Device 218, which communicate with each other via a Bus 232.

The Processing Device 202 represents one or more general-purpose processing devices such as a microprocessor, a central processing unit, or the like. More particularly, the Processing Device 202 may be a complex instruction set computing (CISC) microprocessor, reduced instruction set computing (RISC) microprocessor, very long instruction word (VLIW) microprocessor, Scaler Board, or processor implementing other instruction sets, or processors implementing a combination of instruction sets. The Processing Device 202 may also be one or more special-purpose processing devices such as an application specific integrated circuit (ASIC), a field programmable gate array (FPGA), a digital signal processor (DSP), network processor, or the like. The Processing Device 202 may be configured to execute Processing Logic 226 for performing various operations and steps discussed herein.

The Computer 200 may further include a Network Interface Device 208. The Computer 200 also may include a Video Display Unit 210 (e.g., a liquid crystal display (LCD), LED display, OLED display, plasma display, a projector, a cathode ray tube (CRT), any suitable display described herein, or any other suitable display), an alphanumeric or other input device 212 (e.g., a keyboard), a cursor control or other Input Device 214 (e.g., a mouse, stylus, pen, touch-sensitive input device, Touch Input Device 105, etc.), and a Signal Generation Device 216 (e.g., a speaker).

The Data Storage Device 218 may include a non-transitory Computer-accessible Storage Medium 230 (also known as a non-transitory computer-readable storage medium or a non-transitory computer-readable medium) on which is stored one or more sets of instructions (e.g., Software 222) embodying any one or more of the methodologies or functions described herein. The Software 222 may also reside, completely or at least partially, within the Main Memory 204 and/or within the Processing Device 202 during execution thereof by the Computer 200—the Main Memory 204 and the Processing Device 202 also constituting computer-accessible storage media. The Software 222 may further be transmitted or received over a Network 115 via a Network Interface Device 208.

While the Computer-accessible Storage Medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium that is capable of storing, encoding or carrying a set of instructions for execution by the computer and that cause the computer to perform any one or more of the methodologies of the present invention. The term “computer-accessible storage medium” should accordingly be understood to include, but not be limited to, solid-state memories, optical and magnetic media, etc.

### Interactive Display—Connected Computing Device Communications Path

As may be understood in light of this disclosure, enabling an Interactive Display Device 110 to both send data to (e.g., input data) and receive data from (e.g., software data, application data, etc.) each of One or More Connected Computing Devices 112, may require a communications path between each of the One or More Connected Computing Devices 112 and the Interactive Display Device 110 (e.g., a substantially permanent communications path). In particular embodiments, each of the One or More Connected Computing Devices 112 may, for example, be operatively connected to an Interactive Display Device 110 to enable both: (1) transmission of input data (i.e., touch data) from the interactive display 110 to each respective Connected Computing Device 112; and (2) transmission of video data from each connected computing device 112 to the Interactive Display Device 110 (e.g., for display on the interactive display device). In various embodiments the data transmitted via the connection between the Interactive Display Device 110 and the One or More Connected Computing Devices 112 (e.g., via the Interactive Display Controller Device 120) may include, for example: touch data, video data, audio data and/or any combination thereof (e.g., and any other suitable data described herein). In particular embodiments, it may be desirable to create a communications path between the Interactive Display Device 110 and each connected computing device 112 even in situations in which a particular Connected Computing Device 112 is not selected as the current input for the Interactive Display Device 110 (i.e., such that the Interactive Display Device 110 is not currently displaying video data from the particular Connected Computing Device). In this way, the communications path may enable the Interactive Display System 100 to display data (e.g., a software application from a connected computing device 112 (e.g., Connected Computing Device A 112A) that is not currently the selected video source. In various embodiments, the data from the connected computing device 112 may include, for example: (1) preview data (e.g., a preview, screen shot, or substantially live view of what is currently being displayed by the connected computing device 112); (2) application data (i.e., data regarding what applications are installed on the connected computing device 112 and available for use on the Interactive Display Device 110; (3) data regarding one or more applications running on the connected computing device 112 (e.g., such that the interactive display device can display an application running on a first Connected Computing Device 112A while a second Connected Computing Device 112B is selected as the video source, for example, overlaid on the video from the second connected computing device 112B as part of the on screen display for the Interactive Display Device 110); and/or (4) any other suitable data.

A particular embodiment of an Interactive Display System 100 may, for example, be configured to enable and facilitate a permanent communications pathway between an Interactive Display Device 110 and each of a plurality of connected computing devices 112 (e.g., even between the Interactive Display Device 110 and each connected device that is not the currently active video source for the Interactive Display Device 110). In various embodiments, the permanent communications pathway is facilitated by the Interactive Display Controller Device 120. In particular embodiments, the Interactive Display System 100 is configured to facilitate the permanent communication pathway via an existing connection between each of the One or More Connected Computing Devices 112 and the Interactive Display Device 110. As such, various embodiments of the Interactive Display System 100 described herein may increase a functionality of an Interactive Display Device 110 without requiring: (1) a user to connect the interactive display device to any of the connected computing devices using any additional cables; (2) a user to connect any of the connected computing devices or the interactive display device to any network; (3) any of the connected computing devices to establish a wireless connection with the interactive display device; and/or (4) a user to take any additional action to operatively connect any of the connected computing devices to the interactive display beyond establishing a video and data connection (e.g., as the user would for an interactive display system that simply cycles which of the connected computing devices the interactive display device is displaying based on a selected input and provides touch input data to the selected connected computing device).

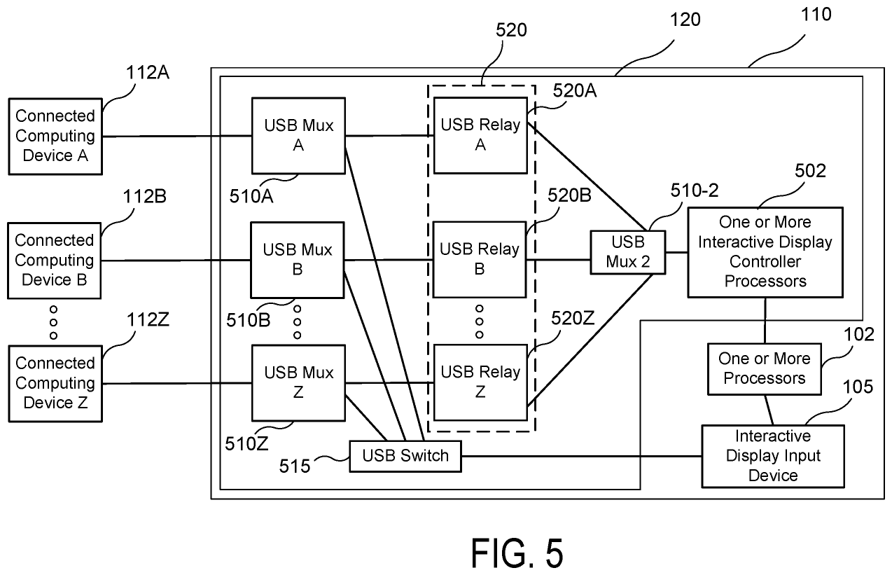

In particular embodiments, the Interactive Display System 100 includes a communication path that enables a first connected computing device (e.g., Connected Computing Device A 112A), acting as a USB Host to both transmit data to and receive data from a connected Interactive Display Controller Device 120 (e.g., a One or More Interactive Display Controller Processors 502 for the Interactive Display Controller Device 120) that is also acting as a USB host. Although the following will generally be described as enabling a communication path between the Connected Computing Device 112 and the Interactive Display Controller Device 120 (e.g., which may, in turn, be operatively connected to the Interactive Display Device 110), it should be understood that various other embodiments may enable a communications path between each Connected Computing Device 112 and the Interactive Display Device 110 shown in FIG. 1 (e.g., such as in embodiments in which the Interactive Display Device 110 comprises the Interactive Display Controller Device 120). As may be understood by one skilled in the art, when two USB devices are connected, a first of the USB devices generally acts as a USB host and a second of the USB devices generally acts as a USB device. Using the communications path and architecture described herein, the Interactive Display System 100 may facilitate a connection between and data transfer between two different devices that are both acting as USB hosts (e.g., via a USB relay, such as any USB relay described herein). FIG. 5 depicts an exemplary embodiment of an Interactive Display System 100 that utilizes one or more USB relays 520 in order to facilitate a communications path between two USB hosts (e.g., each of the One or More Connected Computing Devices 112 and the One or More Interactive Display Controller Processors 502 of the Interactive Display Controller Device 120).

As may be understood from FIG. 5, the Interactive Display System 100, in the embodiment shown in this figure, comprises an Interactive Display Device 110 (e.g., such as any suitable interactive display device described herein, which may incorporate the Interactive Display Controller Device 120 shown in FIG. 3) and a plurality of Connected Computing devices 112A, 112B, . . . 112Z. In the embodiment shown in this figure, there are three connected computing devices (Connected Computing Device A 112A, Connected Computing Device B 112B, and Connected Computing Device Z 112Z). It should be understood in light of this disclosure, that various other embodiments of an Interactive Display System 100 may include any suitable number of Connected Computing Devices 112 (e.g., zero connected computing devices, one connected computing device, two connected computing devices, three connected computing devices, four connected computing devices, up to five connected computing devices, up to ten connected computing devices, up to twenty connected computing devices, and/or any other suitable number of connected computing devices).

As may be understood from FIG. 5, in particular embodiments, each of the One or More Connected Computing Devices 112 may be operatively connected to (e.g., coupled to) both a respective USB Relay 520 and an Interactive Display Device Input Device 105. In various embodiments, the One or More Connected Computing Devices 112 may be connected to each of the respective USB Relay 520 and the Interactive Display Device Input Device 105 via one or more USB Multiplexers 510 and/or USB switch(es) 115. For example, in the embodiment shown in FIG. 5, Connected Computing Device A 112A is operatively connected to USB Relay A 520A via a USB Mux 510A. In this embodiment, Connected Computing Device A 112A is also operatively connected to the Interactive Display Device Input Device 105 via the USB Mux 510 via and via a USB Switch 515. As may be understood from this figure, USB Relay A 520A is further operatively coupled to the One or More Interactive Display Controller Processors 502 of the Interactive Display Controller Device 120 (e.g., via a second USB Mux 2 510-2). As may be understood from this figure, the USB Relay A 520A acts as a USB device to both Connected Computing Device A 112A (acting as a USB host to USB Relay A) and to the One or More Interactive Display Controller Processors 502 (acting as a USB host to USB Relay A).

In particular embodiments, each USB relay 520, configured as a USB device to both connected host devices, is configured to pass one or more pieces of data received from a first USB host operatively connected to the USB Relay 520 (e.g., acting as a USB device to the first USB host 520A) to a second USB host that is also operatively connected to the USB relay 520 (e.g., such that the second USB host 502 receives the one or more pieces of data from the USB relay 520 acting as a USB device to the second USB host 502). In this way, the USB relay 520 is configured to pass data between each connected computing device 112 and the One or More Interactive Display Controller Processors 502, where each of the Connected Computing Devices 112 and the One or More Interactive Display Controller Processors 502 are configured as respective USB hosts. In this way, the USB relay 520 may, for example, be configured to act as a pass-through USB device to each connected USB host (i.e., the connected computing device 112 and the One or More Interactive Display Controller Processors 502) and mirror data received from either USB host to the other (e.g., or make the data available to the opposite USB host from the USB relay/device).

In the embodiment shown in FIG. 5, each of the remaining connected computing devices 112 (i.e., Connected Computing Device B 112B . . . Connected Computing Device Z 112Z) may be similarly operatively coupled to a respective USB Relay 520 (i.e., USB Relay B 520B, USB Relay Z 520Z) via a USB Mux 520. Each respective USB Relay 520 (i.e., USB Relay B 520B, USB Relay Z 520Z) may similarly be operatively coupled to the One or More Interactive Display Controller Processors 502, for example, via a second USB Mux 510. Each connected computing device 112 (i.e., Connected Computing Device B 112B . . . Connected Computing Device Z 112Z) may be further operatively coupled to the interactive display input device 105, for example, via any suitable combination of one or more USB switches, one or more USB hubs, one or more USB multiplexers, etc.

Although the embodiment shown in this figure shows the USB Relay A 520A operatively connected to both the Connected Computing Device A 112A and the One or More Interactive Display Controller Processors 502 via respective USB Muxes 510, it should be understood in light of this disclosure that various other embodiments of a USB relay enabled communication channel between the One or More Interactive Display Controller Processors 502 and each connected computing device 112 may include, for example: (1) a substantially direct connection between each Connected Computing Device 112 and a respective USB Relay 520 (e.g., and/or one or more USB relays 520); (2) a substantially direct connection between each respective USB Relay 520 and the One or More Interactive Display Controller Processors 502; (3) a connection between each Connected Computing Device 112 and a respective USB Relay 520 (e.g., and/or one or more USB relays 520) via any suitable combination of one or more USB switches, one or more USB hubs, one or more USB multiplexers, etc.; and/or (4) a connection between each respective USB Relay 520 and the One or More Interactive Display Controller Processors 502 via any suitable combination of one or more USB switches, one or more USB hubs, one or more USB multiplexers, etc.

In the embodiment shown in FIG. 5, each Connected Computing Device 112, acting as USB host (e.g., configured as a USB Host) may be connected to the Interactive Display Input Device 105 that is acting as a USB device. As may be understood by one skilled in the relevant field, a USB Host is configured to act as a master device for an entire bus. A USB device, may, for example, act as a slave to the host. In various embodiments, a computer is generally configured as a USB host, while peripherals (e.g., mice, printers, etc.) are generally configured as USB devices.

In any embodiment described herein, the Interactive Display Device 110 comprises the One or More Interactive Display Controller Processors 502. In any other embodiment described herein, the Interactive Display Controller Device 120 may comprise the One or More Interactive Display Controller Processors 502. In some embodiments, the Interactive Display Device 110 may further comprise One or More Processors 102, which may, for example, be operatively coupled to the One or More Interactive Display Controller Processors 502.

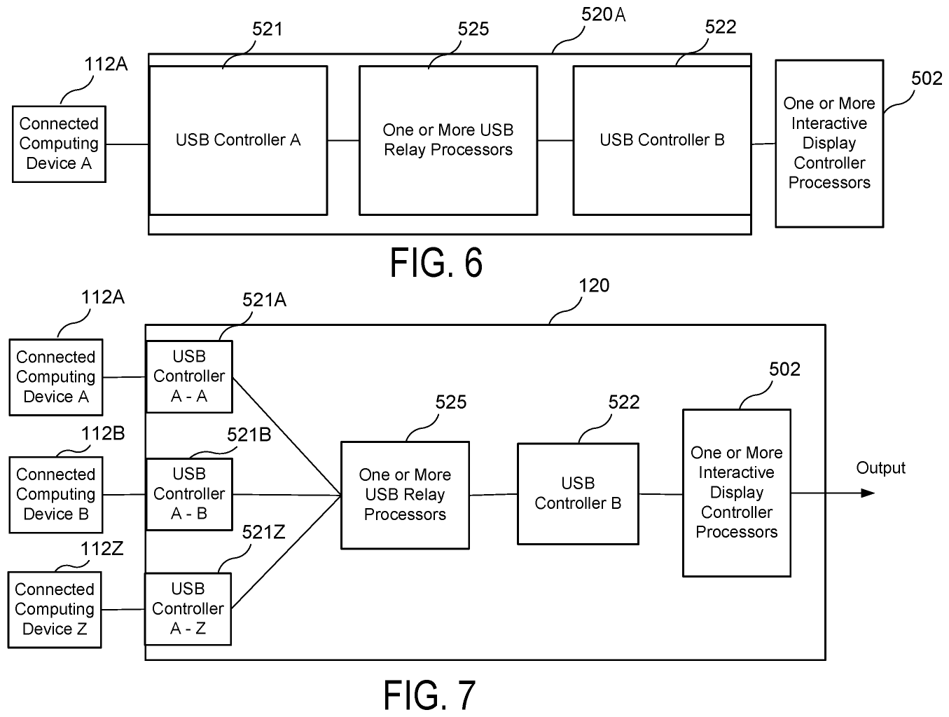

FIG. 6 depicts an exemplary USB Relay 520 according to particular embodiments. In the embodiment shown in this figure, each USB Relay 520 comprises: (1) a First USB Controller (i.e., USB Controller A 521) operatively connected to a first connected computing device (i.e., Connected Computing Device A 112A); (2) a Second USB Controller (i.e., USB Controller B 522) operatively connected to the One or More Interactive Display Controller Processors 502 (e.g., or any other suitable processor described herein); and (3) One or More USB Relay Processors 525 operatively coupled to each of the First and Second USB Controllers (USB Controller A 521 and USB Controller B 522). As may be understood in light of this disclosure, the One or More USB Relay Processors 525 are configured as a USB device to each of two respective USB hosts (e.g., Connected Computing Device A 112A and the One or More Interactive Display Controller Processors 502). In particular embodiments, the One or More USB Relay Processors 525 are configured to pass data received from a Connected Computing Device 112 (i.e., Connected Computing Device A 112A) via USB Controller A 521 to the One or More Interactive Display Controller Processors 502 via USB Controller B 522. In particular embodiments, the One or More USB Relay Processors 525 comprise any suitable processor (e.g., microprocessor) or combination of processors. In various embodiments, each of USB Controller A 521 and USB Controller B 522 may be operatively coupled to a respective processor, and each respective processor may, in turn, be operatively coupled to one another. In still other embodiments, the USB Relay 520 may comprise any suitable configuration of One or More USB Relay Processors 525 such that the USB Relay 520 is configurable as a USB device to each of two connected USB hosts, and further configured to pass data received form each connected USB host to the other.

In particular embodiments, the system is configured enable each USB Relay 520 to alternatively be configured as a USB host or a USB device. In particular, in the embodiment of a USB Relay 520A shown in FIG. 6, the USB Relay 520A is configured to cause USB Controller A 521 to be configured as a USB device to Connected Computing Device A 112A (configured as a USB host). In some embodiments, the One or More USB Relay Processors are configured to act as a USB Host between USB Controllers A and B 521, 522 (e.g., in order to pass data between USB Controllers A and B 521, 522, both of which are configured as USB Devices.

In various embodiments and referring once again to FIG. 5, the Interactive Display System is configured to transfer data between two Connected Computing Devices (e.g., Connected Computing Device A 112A and Connected Computing Device B 112B), each of which are configured as USB hosts. For example, the system may cause data to flow between Connected Computing Device A 112A and Connected Computing Device B 112B by: (1) receiving data from Connected Computing Device A 112A at USB Mux A 510A; (2) passing the data from USB Mux A 510A to USB Relay A 520A, configured as a USB Device; (3) passing the data from USB Relay A 520A to the One or More Interactive Display Controller Processors 502 via USB Mux 2 510-2; (4) determine, using the One or More Interactive Display Controller Processors 502, that the data is meant for Connected Computing Device B 112B; (5) in response to determining that the data is meant for Connected Computing Device B 112B, passing the data from the One or More Interactive Display Controller Processors 502 (configured as a USB host) to USB Relay B 520B via USB Mux 2 510-2; and (6) passing the data from USB Relay B 520B (configured as a USB device) to the Connected Computing Device B 112B (configured as a USB Host) via USB Mux B 510B. In this way, the system is configured to pass data between/among any of the One or More Connected Computing Devices 112 via a combination of One or More USB Relays 520 and the One or More Interactive Display Controller Processors 502 using the Interactive Display Controller Device 120.

In some embodiments, the USB Relay 520 may comprise any suitable number of USB controllers. For example, in the embodiments shown in FIGS. 5 and 6, each Connected Computing Device 112 may be operatively connected to the Interactive Display Controller Device 120 (e.g., One or More Interactive Display Controller Processors 502) via a respective USB Relay 520 (each of which may, for example, comprise a pair of USB controllers 521, 522 as shown in FIG. 6). In other embodiments, a USB Relay 520 may comprise any other suitable combination of USB controllers for facilitating data pass-through (via One or More USB Relay Processors 525) between two or more connected USB hosts. For example, FIG. 7 depicts an exemplary USB Relay 520 according to yet another embodiment, disposed within the Interactive Display Controller Device 120. In the embodiment shown in this figure, the USB Relay 520 comprises a plurality of USB Controllers (USB Controller A—A 521A, USB Controller A—B 521B, . . . USB Controller A—Z 521Z), each of which are operatively coupled to a respective Connected Computing Device (Connected Computing Device A 112A, Connected Computing Device B 112B, . . . and Connected Computing Device Z 112Z). Each of the plurality of USB Controllers 521 are operatively connected to the One or More USB Relay Processors 525, which are operatively connected to a second USB controller 522 which, in turn, is operatively connected to the One or More Interactive Display Controller Processors 502. In the configuration shown in this example, the USB Relay 520 is configured to receive data at the one or more USB relay processors 525 from the One or More Connected Computing Devices 112 via respective USB controllers (USB Controller A—A 521A, USB Controller A—B 521B, . . . USB Controller A—Z 521Z). The USB Relay Processors (e.g., the one or more USB Relay processors 525) is then configured to pass the data to the One or More Interactive Display Controller Processors 502 via the second USB controller 522.

As may be understood in light of this disclosure, and particularly in light of FIGS. 5, 6 and 7, the USB Relay 520 (e.g., and/or USB Relays 520A, 520B, . . . 520Z) may include any suitable number of individual relays having any suitable configuration of processor(s) and USB controllers that are configurable as a USB device to respective USB hosts for the purpose of passing-through (e.g., mirroring) data between the connected USB hosts. In some embodiments, an induvial USB relay may comprise one processor and one USB controller. In such embodiments, each individual USB relay may be operatively coupled to a second USB Relay, such that each USB relay is configured as a device to a separate USB host and each are further configured to mirror data (e.g., pass data through) to one another for the purposes of serving as the communications channel between the two distinct USB hosts.

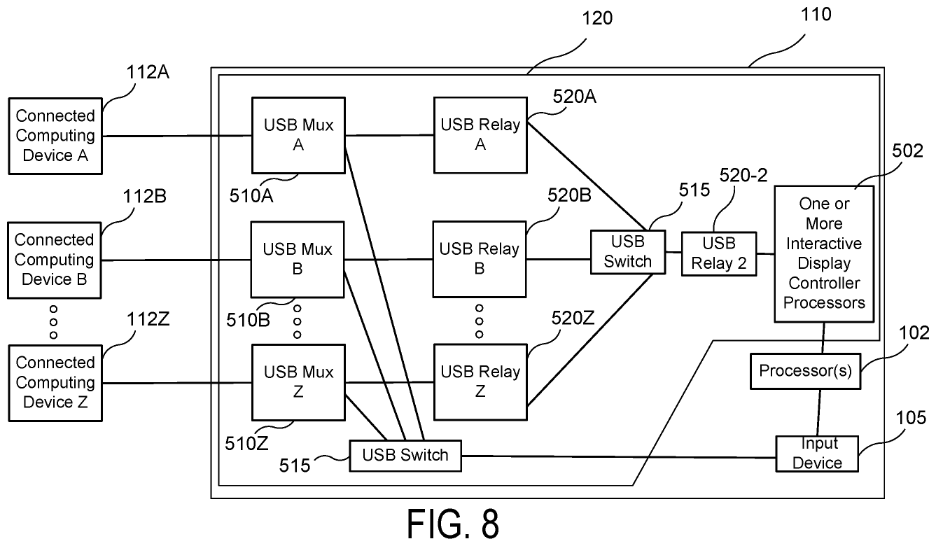

FIG. 8-10 depict USB topologies for various embodiments of an Interactive Display System 100 that utilizes One or More USB Relays 520 (e.g., a USB Relay 520 comprising one or more individual USB Relays, such as USB Relay A 520A, USB Relay B 520B, etc.) to facilitate a data communications path between two different computing devices, each configured as a USB host. As may be understood from FIG. 8, in particular embodiments of an Interactive Display System 100, each of the Connected Computing Devices 112 (i.e., Connected Computing Device A 112A, Connected Computing Device B 112B . . . Connected Computing Device Z 112Z) may be operatively coupled to a respective USB Relay (i.e., USB Relay A 520A, USB Relay B 520B, USB Relay Z 520Z), for example, via a respective USB Mux (i.e., USB Mux A 510A, USB Mux B 510B, USB Mux Z 510Z). Each respective USB Relay 520 (i.e., USB Relay A 520A, USB Relay B 520B, USB Relay Z 520Z) may similarly be operatively coupled to the One or More Interactive Display Controller Processors 502, for example, via a USB Switch 515 and a Second USB Relay (e.g., USB Relay 2 520-2). In the embodiment shown in this figure, each respective USB Relay (i.e., USB Relay A 520A, USB Relay B 520B, . . . USB Relay Z 520Z) may be configured as a USB device to its respective Connected Computing Device (i.e., Connected Computing Device A 112A, Connected Computing Device B 112B . . . Connected Computing Device Z 112Z), each of which are configured as a USB host. The second USB Relay (e.g., USB Relay 2 520-2) is then configured as a USB device to the One or More Interactive Display Controller Processors 502, which is configured as a USB host. The configuration shown in FIG. 8 is, in some respects, similar to the USB Relay 520 described with respect to FIG. 7. In particular other embodiments, the USB Relay 520 may utilize one or more USB-ETH adaptors (e.g., and or ETH-USB adaptors), one or more Ethernet switches, and/or any other configuration suitable for passing USB data between two different hosts, while acting as a USB device to each host.

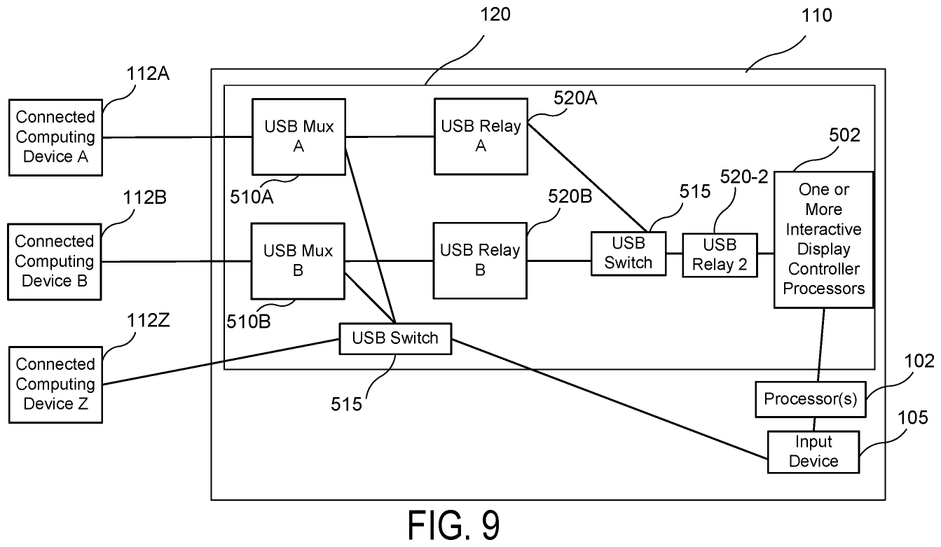

FIG. 9 depicts a USB topology for an Interactive Display System 100 according to yet another embodiment. In the embodiment shown in this figure, each of one or more connected computing devices (e.g., Connected Computing Device A 112A and Connected Computing Device B 112B) may be operatively connected to the One or More Interactive Display Controller Processors 502 via one or more USB relays 520. As may be understood from this figure, the Interactive Display System 100 may further comprise a Connected Computing Device Z 112Z that does not include the data communication channel described herein (e.g., as Connected Computing Device Z 112Z is coupled to the Interactive Display Input Device 105, which is configured as a USB device to the Connected Computing Device Z 112Z). As such, as may be understood in light of this disclosure, at least some connected computing devices may not be configured to transmit data as a USB host to the One or More Interactive Display Controller Processors 502 that is also acting as a USB host (e.g., via one or more USB relays).

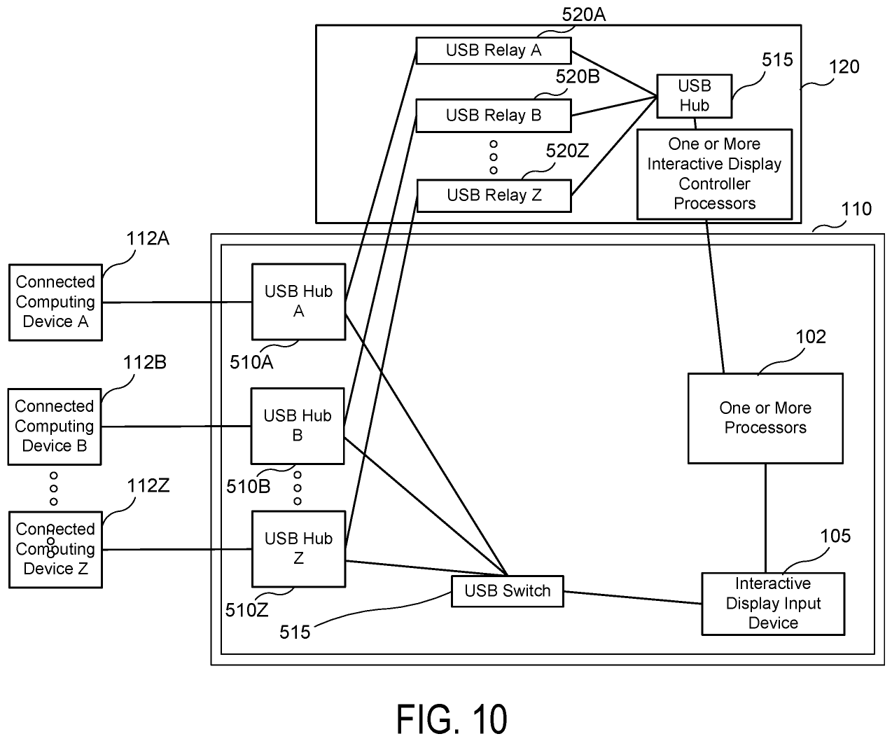

FIG. 10 depicts a USB topology for an Interactive Display System 100 according to another embodiment. In the embodiment shown in this figure, the USB Relay 520 is similar to the USB Relay 520 shown in FIG. 5. However, in the embodiment shown in FIG. 10, the USB Relay 520 is embodied as a separate device to the Interactive Display Device 110. In particular embodiments an Interactive Display Controller Device 120 such as the Interactive Display Controller Device 120 shown in FIG. 1 may comprise the one or more USB relays 520 configured to facilitate the communications path between the One or More Connected Computing Devices 112 and the One or More Interactive Display Controller Processors 502 (i.e., the Interactive Display Device 110 may not comprise the one or more USB relays 520). In such embodiments, the one or more USB Relays 520 may be embodied as a stand-alone device configured to be operatively coupled to the Interactive Display Device 110 in order to facilitate the communications channel described herein (e.g., in the case of an Interactive Display Device 110 that simply comprises a display and a touch or other input device). In the embodiment shown in FIG. 10, the USB Relay 520 may be coupled to the interactive display device in any suitable manner (e.g., via a suitable data cable, such as any USB or other data cable described herein).

### Exemplary System Platform

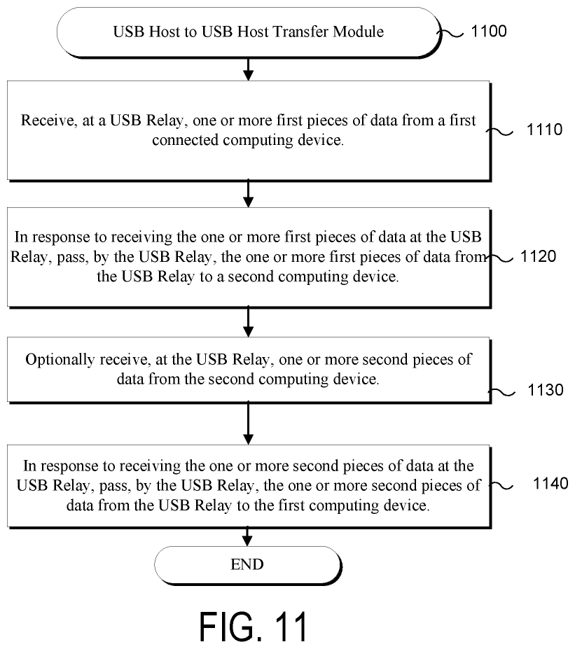

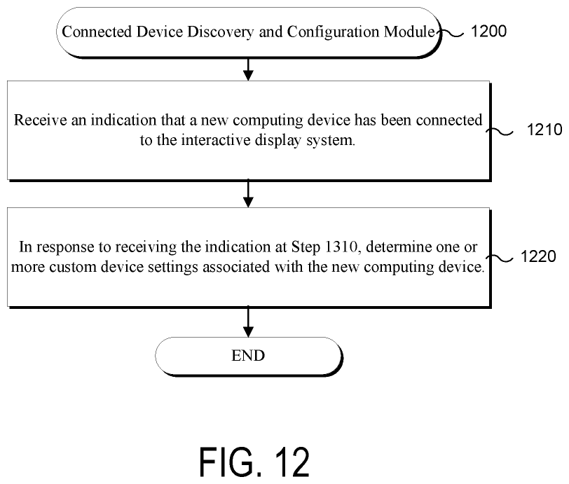

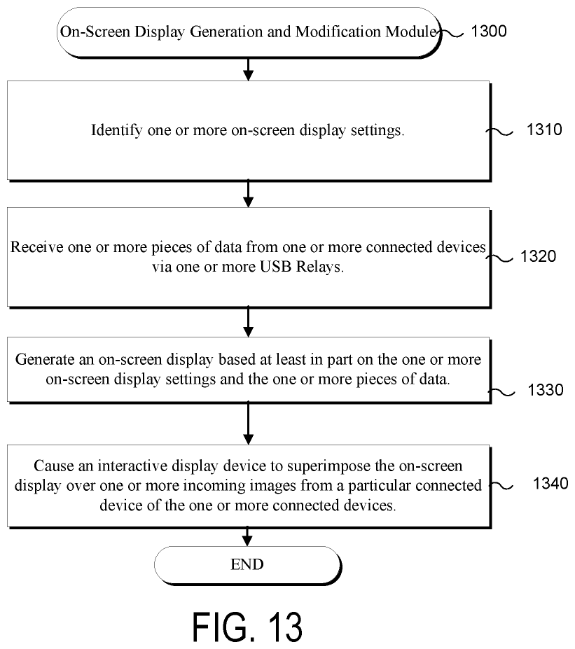

Various embodiments of an Interactive Display System 100 may be implemented in the context of any suitable interactive display device, system of interactive display devices, or any other suitable system. For example, particular embodiments may be implemented on an interactive display device, touch screen display device, one or more remote servers, or any other suitable computing device or combination of computing devices. Various aspects of the system's functionality may be executed by certain system modules, including a USB Host to USB Host Data Transfer Module 1100 (FIG. 11); a Connected Device Discovery and Configuration Module 1200 (FIG. 12); and an On-Screen Display Generation and Modification Module 1300 (FIG. 13). These modules are discussed in greater detail below.

Although these modules are presented as a series of steps, it should be understood in light of this disclosure that various embodiments of the USB Host to USB Host Data Transfer Module 1100; Connected Device Discovery and Configuration Module 1120; and On-Screen Display Generation and Modification Module 1300 described herein may perform the steps described below in an order other than in which they are presented. In still other embodiments, the USB Host to USB Host Data Transfer Module 1100; Connected Device Discovery and Configuration Module 1200; and On-Screen Display Generation and Modification Module 1300 may omit certain steps described below. In various other embodiments, the USB Host to USB Host Data Transfer Module 1100; Connected Device Discovery and Configuration Module 1200; and On-Screen Display Generation and Modification Module 1300 may perform steps in addition to those described (e.g., such as one or more steps described with respect to one or more other modules, etc.).

### USB Host to USB Host Data Transfer Module

In particular embodiments, the Interactive Display System 100 is configured to provide a communications path between One or More Connected Computing Devices 112 and an Interactive Display Device 110 (e.g., and/or an Interactive Display Controller Device 120 operatively connected to the Interactive Display Device 110), where both the One or More Connected Computing Devices 112 and the Interactive Display Device 110 (e.g., and/or an Interactive Display Controller Device 120 operatively connected to the Interactive Display Device 110) are configured as USB hosts. As described herein, the Interactive Display System 100 may, for example, comprise one or more USB relays 520 configured as a USB device to both the Interactive Display Device 110 and each of the one or more connected computing devices. The one or more USB relays 520 may be further configured to pass through data received from either of the connected USB hosts to the USB host on the other side of the USB relay (i.e., from the Interactive Display Device 110 to a particular Connected Computing Device 112A, from a particular Connected Computing Device 112A to the Interactive Display Device 110, etc.).

Turning to FIG. 11, in particular embodiments, when executing the USB Host to USB Host Data Transfer Module 1100, the system is configured to, at Step 1110, receive, at a USB Relay, one or more first pieces of data from a first connected computing device. In particular embodiments, the USB Relay is configured as a USB device, which is operatively connected to the first connected computing device, which is configured as a USB host. In particular embodiments, the first connected computing device is a device connected to an interactive display (e.g., via one or more video cables, via a USB cable, via a combination of video and USB cables, etc.), such as one of the One or More Connected Computing Devices 112 described herein. In various embodiments, the first connected computing device is a device connected to an interactive display via a USB Relay (e.g., such as any suitable USB Relay described herein). FIG. 1 depicts an exemplary Interactive Display System 100 that includes a connected computing device (e.g., Connected Computing Device A 112A that is operatively coupled to an Interactive Display Controller Device 120). In the embodiment shown in that Figure, both Connected Computing Device A 112A and the Interactive Display Controller Device 120 may be configured as USB Hosts and operatively connected via a USB Relay (e.g., one or more USB Relays) configured as a USB device to each USB host.

In particular embodiments, the one or more first pieces of data may include, for example: (1) image and/or preview data (e.g., a preview, screen shot, or substantially live view of what is currently being displayed by the first connected computing device); (2) application data (i.e., data regarding what applications are installed on the first connected computing device and available for use on the Interactive Display Device 110; (3) data regarding one or more applications running on the first connected computing device (e.g., such that the interactive display device can display an application running on the first connected computing device while a second connected computing device is selected as the video source, for example, overlaid on the video from the second connected computing device as part of the on screen display for the interactive display device); (4) device data identifying the first connected computing device (e.g., a type of device, a unique identifier associated with the device, discovery data, etc.); and/or (5) any other suitable data.

In various embodiments, as described herein, the USB Relay comprises one or more USB Relay processors, which may, for example, be configured to receive the one or more first pieces of data via a first USB controller. In particular embodiments, the first connected computing device, as the USB Host, may transmit the one or more first pieces of data to the USB Device (i.e., the USB Relay) such that the USB Relay (i.e., as the USB device) receives the one or more first pieces of data.

Continuing to Step 1120, the system is configured to pass the one or more first pieces of data from the USB Relay to a second computing device (e.g., an Interactive Display Controller Device 120, which may, in some embodiments, be operatively coupled to and/or integrated into an Integrated Display Device 110). In various embodiments, the one or more USB Relay Processors 525 are configured to transfer the one or more first pieces of data to the second computing device via a second USB Controller 522 in the USB Relay 520. In particular embodiments, the USB relay is configured as a USB device to each of the first and second computing devices, each of which are configured as USB hosts. FIG. 1 depicts an exemplary Interactive Display System 100 that includes a connected computing device (e.g., Connected Computing Device A 112A that is operatively coupled to an Interactive Display Controller Device 120). In the embodiment shown in that Figure, both Connected Computing Device A 112A and the Interactive Display Controller Device 120 may be configured as USB Hosts and operatively connected via a USB Relay (e.g., one or more USB Relays) configured as a USB device to each USB host.

In various embodiments, as described herein, the USB Relay comprises one or more USB Relay Processors 525, which may, for example, be configured to pass (e.g., transmit and/or otherwise make available) the one or more first pieces of data to the second computing device via a Second USB controller. In particular embodiments, the second connected computing device, as the USB Host, may request the one or more first pieces of data from the USB Device (i.e., the USB Relay) such that the USB Relay (i.e., as the USB device) transmits the one or more first pieces of data in response to the request. In such embodiments, the USB Relay may receive the one or more pieces of data at Step 1110 and retain the data until prompted to transmit it by the second computing device. In other embodiments, the USB Relay may directly transmit the one or more first pieces of data to the second computing device.

Next, at Step 1130, the system is configured to optionally receive one or more second pieces of data from the second computing devices at the USB Relay. In particular embodiments, as may be understood in light of this disclosure, the Interactive Display System 100 is configured to transmit input data (e.g., received via a Touch Input Device 105 of the Interactive Display Device 110) to the first connected computing device (e.g., or any suitable connected computing device of the One or More Connected Computing Devices 112), for example, via one or more USB Relays. In such embodiments, the system may be configured to receive the one or more second pieces of data (e.g., in the form of input data) at the USB Relay (e.g., at the Interactive Display Controller Device 120 comprising a USB Relay 520 as in any embodiment described herein). In still other embodiments, the system is configured to transmit command data to the first connected computing device (e.g., or any suitable connected computing device of the One or More Connected Computing Devices 112) from the Interactive Display Controller Device 120 via the USB Relay. In such embodiments, the command data may include, for example: (1) one or more commands to launch an application; (2) one or more commands to modify a currently running application on the first connected computing device; (3) one or more commands to store one or more pieces of data on the first connected computing device (e.g., and/or the one or more pieces of data for storage; (4) one or more commands to delete one or more pieces of data stored on the first connected computing device; and/or (5) any other suitable command data. In various embodiments, the one or more second pieces of data comprise the input data, the command data, and/or any other data described herein or combination of data thereof.

At Step 1140, the system is configured to pass (e.g., transmit and/or otherwise make available) the one or more second pieces of data from the USB Relay 520 to the first computing device. In this way, the USB relay may be configured to mirror and otherwise pass data between both USB hosts (e.g., the first connected computing device and the Interactive Display Controller Device 120). In particular embodiments the Interactive Display Controller Device 120 is configured to determine a destination device of One or More Connected Computing Devices 112 prior to passing the one or more second pieces of data to a particular one of the One or More Connected Computing Devices 112 via the USB Relay 520.

In a particular example, in response to a user selecting an indicia, on an on-screen display being displayed on an Interactive Display Device 110 by an Interactive Display Controller Device 120 to launch an annotation application, the system may, for example: (1) transmit a request to launch the annotation application from the Interactive Display Controller Device 120 (configured as a USB Host) to the USB Relay (configured as a USB device to the Interactive Display Controller Device 120's USB host); (2) receive the request at the USB Relay from the Interactive Display Controller Device 120; (3) pass the request from the USB Relay (configured as a USB device) to a connected computing device on which the annotation application is installed (configured as a USB Host); (4) receive the request at the connected computing device on which the annotation application is installed; (5) cause the connected computing device to launch the annotation application; (6) receive, from the connected computing device, via the USB relay, application data associated with the annotation application at the Interactive Display Controller Device 120; (7) modify, using the Interactive Display Controller Device 120, an on-screen display to include the annotation application; and (8) cause, by the Interactive Display Controller Device 120, the Interactive Display Device 110 to superimpose the generated on-screen display over one or more incoming images from a second connected computing device (e.g., a second computing device operatively connected to the Interactive Display Controller Device 120, such as Connected Computing Device B 112B). In this example, the second connected computing device may serve as the selected video source for the Interactive Display Controller Device 120 (e.g., and by extension, the Interactive Display Device 110) such that both the request to launch the annotation application, and the application data itself are transmitted between the first connected computing device (e.g., Connected Computing Device A 112A) and the Interactive Display Controller Device 120 without the first connected computing device (e.g., Connected Computing Device A 112A) being the currently selected video input for the Interactive Display Controller Device 120.

In various embodiments, the system may comprise a plurality of USB Relays (e.g., or a USB relay configured to connect a plurality of connected devices to an interactive display device. In this way, the system may be configured to provide a substantially simultaneous communications path between each Connected Computing Device 112 and the Interactive Display Controller Device 120 (e.g., a One or More Interactive Display Controller Processors 502 driving the Interactive Display Controller Device 120). As such, the system may be configured to receive data from each of the plurality of connected communication devices substantially simultaneously (e.g., simultaneous) in order to display data from any one or more of the connected devices (e.g., as part of an on-screen display), modify data on the one or more connected devices, etc., regardless of which connected computing device is currently providing the video input for the Interactive Display Controller Device 120 and/or the Interactive Display Device 110.

### Connected Device Discovery and Configuration Module

In particular embodiments, the Interactive Display System 100 is configured to customize a user experience for a user utilizing the Interactive Display Device 110. In various embodiments, the system may, for example, be configured to: (1) modify one or more interactive display system settings; (2) modify an appearance of one or more interactive display system interfaces; (3) modify a contents of one or more interactive display system interfaces; (4) modify an availability of one or more applications for access and use by the user on the Interactive Display Device 110; and/or (5) implement any other setting, feature, configuration, etc. for a user of the Interactive Display Device 110

Turning to FIG. 12, in particular embodiments, when executing the Connected Device Discovery and Configuration Module 1200, the system is configured to, at Step 1210, receive an indication that a new computing device has been connected to the interactive display system. In various embodiments, the system is configured to identify the newly connected computing device via any suitable USB discovery technique (e.g., based on any suitable USB connection described herein). In particular embodiments, the system is configured to identify a particular user profile based at least in part on the indication of the new computing device connection. For example, the system may be configured to identify one or more user preferences based at least in part on the identified connected device. In some embodiments, the system may be configured to store one or more user preferences in association with a particular device or unique identifier associated with the device (e.g., rather than and/or in addition to storing the user preferences in association with a user profile).

Continuing to Step 1220, the system is configured to determine one or more custom device settings associated with the new computing device. The system may, for example, determine a device ID for the newly connected device. In response to determining the device ID, the system may be configured to retrieve one or more user preferences. The user preferences may include, for example: one or more user interface formatting preferences, one or more device preferences (e.g., settings such as brightness, etc.). In still other embodiments, system is configured to determine any suitable configuration data for the Interactive Display Device 110 (e.g., the Interactive Display Controller Device 120) based at least in part on data received at the Interactive Display Controller Device 120 from a particular Connected Computing Device (e.g., Computing Device Z 112Z). In any embodiment described herein, the one or more user interface formatting preferences may include, for example: (1) a position of one or more user interface elements; (2) a size of one or more user interface elements; (3) one or more contents of one or more user interface elements; and/or (4) any other suitable user interface preferences.

In response to determining the one or more custom device settings, the system may be configured to modify one or more device settings (e.g., for the interactive display device) based on the one or more custom device settings. In still other embodiments, the system may modify a generated on-screen display based at least in part on the identified user settings. In some embodiments, in response to determining that a user has connected their user device to the Interactive Display 110 (e.g., the Interactive Display Controller Device 120), the system may be configured to retrieve the user's device settings and apply them when generating the on-screen display. In this way, the system may be configured to apply a user's preferred settings in response to the user plugging their computer into the interactive display devices, rather than requiring the user to login to a user account, select their own settings, etc.

In particular embodiments, the system is configured to determine one or more custom device settings, which may, for example, include one or more available software application settings. In particular embodiments, one or more software applications may be installed locally on the Interactive Display Controller Device 120, but generally unavailable to a user of the Interactive Display Device 110 (e.g., while the Interactive Display Device 110 is operatively connected to the Interactive Display Controller Device 120). The one or more software applications may include, for example, one or more dormant software applications that are not visible to, or available for use by a user of the Interactive Display Device 110 (e.g., while the Interactive Display Device 110 is operatively connected to the Interactive Display Controller Device 120). In such embodiments, the system may be configured to, in response to receiving the indication that a computing device has been connected to the Interactive Display System 100 at Step 1210, determine one or more custom device settings associated with the newly connected computing device that include one or more settings related to an availability of one or more of the one or more dormant software applications. In this way, the Interactive Display System 100 may be configured to enable the Interactive Display Controller Device 120 to run the one or more dormant software applications (when the one or more dormant software applications are active) and enable a particular Connected Computing Device to store data related to the one or more dormant software applications (e.g., one or more saved documents, profile data, user data, etc.). In various embodiments, the Interactive Display Controller Device 120 may not require additional software maintenance, data security, network access, infrastructure, etc., that may otherwise be required.

As such, in any embodiment described herein, the system may be configured to make the one or more dormant software applications installed on the Interactive Display Controller Device 120 available in response to a connection of at least one connected computing device. In particular embodiments, the system is configured to make the one or more dormant software applications installed on the Interactive Display Controller Device 120 available in response to a particular computing device that also comprises the one or more software applications (e.g., also has the one or more dormant applications installed and available for use).

In a particular embodiment, the Interactive Display Controller Device 120 may make available (e.g., to a user of the Interactive Display Device 110) one or more settings options and/or one or more source switching options (e.g., an option to select among the One or More Connected Computing Devices 112 as the video source for the Interactive Display Device 110) as default. The system may, in further embodiments, be configured to make available the one or more dormant applications (e.g., on the Interactive Display Controller Device 120) in response to a connection of a particular Connected Computing Device (e.g., Connected Computing Device A 112A) to the Interactive Display Controller Device 120. For example, the one or more dormant software applications may include, for example; (1) one or more timer applications; (2) one or more annotation applications; (3) one or more whiteboard applications; (4) etc.

In various embodiments, the Interactive Display Controller Device 120 and the particular Connected Computing Device (e.g., Connected Computing Device A 112A) may be configured to communicate via a suitable USB Relay (e.g., as discussed herein). In particular embodiments, the one or more dormant software applications (e.g., running on the Interactive Display Controller Device 120) may be configured to communicate with the particular Connected Computing Device (e.g., Connected Computing Device A 112A) in order to provide one or more data storage locations on the particular Connected Computing Device (e.g., Connected Computing Device A 112A) for use by the one or more dormant software applications (e.g., running on the Interactive Display Controller Device 120).

For example, a whiteboard application running on the Interactive Display Controller Device 120 (e.g., and configured as a dormant application and made available in response to connection of the particular Connected Computing Device (e.g., Connected Computing Device A 112A) to the Interactive Display Controller Device 120)) may be configured to cause the particular Connected Computing Device (e.g., Connected Computing Device A 112A) to store documents generated in the whiteboard application (e.g., via input on the Interactive Display Device 110) on computer memory associated with the particular Connected Computing Device (e.g., rather than locally on the Interactive Display Controller Device 120). In still other embodiments, the system may be configured to store documents generated via the one or more dormant software applications (e.g., when available) in any other suitable location (e.g., locally on the Interactive Display Controller Device 120, via one or more cloud storage systems, on one or more remote servers, etc.).

### On-Screen Display Generation and Modification Module

In particular embodiments, the Interactive Display Controller Device 120 is configured to generate an on-screen display for display on the Interactive Display Device 110 (e.g., an on-screen display that is superimposed over the top of one or more incoming images from a particular Connected Computing Device). In various embodiments, the system is configured to generate and/or modify the on-screen display based on, for example: (1) one or more custom device settings identified based on a particular Connected Computing Device; (2) one or more software applications running and/or available on one or more connected computing devices and/or the Interactive Display Controller Device 120 (e.g., such as one or more dormant software applications, when available); (3) etc. The system may, for example, at least partially integrate one or more software applications running on the One or More Connected Computing Devices 112 into the on-screen display (e.g., such that the one or more software applications are superimposed over the one or more incoming images from a particular Connected Computing Device). The one or more software applications may include, for example: (1) one or more timer applications; (2) one or more annotation applications; (3) etc. In still other embodiments, the system may generate and/or modify the on-screen display to display a live source preview of one or more unselected sources (e.g., a live preview of one or more connected computing devices that are not the currently selected source for the interactive display device.

Turning to FIG. 13, in particular embodiments, when executing the On-Screen Display Generation and Modification Module 1300, the system is configured to, at Step 1310, identify one or more on-screen display settings. The system may, for example, determine the one or more on-screen display settings based at least in part on one or more identified settings via the Connected Device Discovery and Configuration Module 1200 described herein. In particular embodiments, the one or more on-screen display settings may include one or more user interface formatting preferences such as, for example: (1) a position of one or more user interface elements; (2) a size of one or more user interface elements; (3) one or more contents of one or more user interface elements; and/or (4) any other suitable user interface preferences. In still other embodiments, the one or more on-screen display settings may include one or more on-screen display settings related to an availability of one or more particular software applications installed on the Interactive Display Controller Device 120.

Continuing to Step 1320, the system is configured to receive one or more pieces of data from one or more connected computing devices. The system may, for example, receive any suitable data via any suitable communication channel (e.g., via USB relay) described herein.

Next, at Step 1330, the system is configured to generate the on-screen display based on the one or more on-screen display settings and the one or more pieces of data. The system may, for example, modify a position of one or more user interfaces based on the one or more on-screen display settings, modify the on-screen display to include one or more applications, links, etc. based on the one or more pieces of data, or generate the on-screen display to include any suitable data or configuration based on any factor described herein. For example, in particular embodiments, the system (e.g., the Interactive Display Controller Device 120) may be configured to generate (e.g., render) an on-screen display to include a software application running on a first connected computing device (e.g., Connected Computing Device A 112A, Interactive Display Controller Device 120, and/or any other suitable device) while a second connected computing device (e.g., Connected Computing Device B 112B) is the currently selected video source for the Interactive Display Controller Device 120 (e.g., the Interactive Display Device 110). In still other embodiments, the system (e.g., the Interactive Display Controller Device 120) may be configured to generate (e.g., render) an on-screen display to include a substantially live (e.g., live) video preview of a first connected computing device (e.g., Connected Computing Device A 112A) while a second connected computing device (e.g., Connected Computing Device B 112B) is the currently selected video source for the Interactive Display Controller Device 120 (e.g., the Interactive Display Device 110).

In some embodiments, the system is configured to generate (e.g., render) the on-screen display to include any suitable combination of data from any suitable number of connected device (e.g., substantially simultaneously).

At Step 1340, the system (e.g., the Interactive Display Controller Device 120) is configured to cause the Interactive Display Device 110) to superimpose the generated (e.g., rendered) on-screen display over one or more incoming images from a particular Connected Computing Device. In various embodiments, the particular Connected Computing Device is a connected computing device other than at least one connected device that provided one or more pieces of data that affected the generated on-screen display. In this way, the system may be configured to display data from a connected computing device (e.g., within the on-screen display) that is not the currently selected video source.

### Illustrative Examples

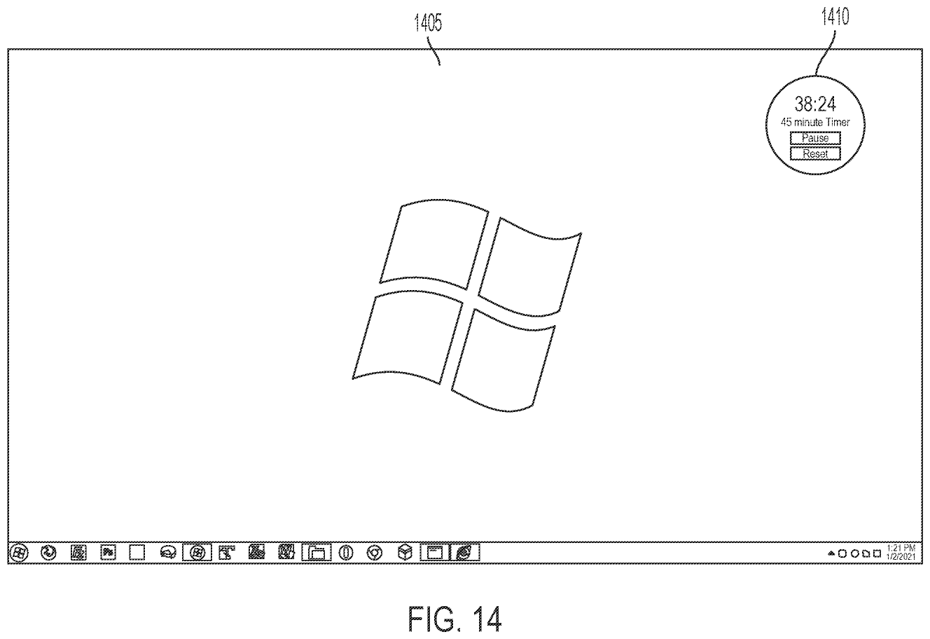

FIG. 14 depicts an exemplary screen display of an Interactive Display System 100 in which an Interactive Display Device 110 is currently displaying incoming images 1405 via a suitable video input from a first computing device. As may be understood from FIG. 14, the Interactive Display Device 110 is currently displaying the desktop from a connected Windows computing device (e.g., laptop). As shown in this figure, the Interactive Display Device 110 is also displaying a timer application 1410 over the laptop's desktop. As may be understood in light of this disclosure, the Interactive Display System 100 (e.g., Interactive Display Controller Device 120), in this example, is displaying the Timer Application 1410 as part of the interactive display device's on-screen display, which is superimposed over the incoming images from the connected laptop (e.g., windows computer). As may be further understood from this disclosure, the laptop is the currently selected video input (e.g., HDMI input) for the Interactive Display Device 110 (e.g., Interactive Display Controller Device 120), which is causing the Interactive Display Device 110 to display the laptop's desktop. Additionally, the Interactive Display System 100 (e.g., Interactive Display Controller Device 120) is generating an on-screen display that includes the Timer Application 1410 and superimposing that on-screen display over the incoming images 1405 (e.g., video feed) from the laptop.

In particular embodiments, the Timer Application 1410 is currently running on a second connected computing device (e.g., or a computing device integrated into the Interactive Display Device 110 or serving as a peripheral and/or console computing device to the interactive display device). The Interactive Display System 100 is receiving data associated with the timer application via a USB relay that is coupled to both the second connected computing device and a One or More Interactive Display Controller Processors producing the on-screen display on behalf of the Interactive Display Device 110 (e.g., embodied as the Interactive Display Controller Device 120). As may be understood from this disclosure, the system is receiving the timer application data via the USB relay that may include, for example: (1) timer data (e.g., time remaining, time elapsed, etc.); (2) visual data related to the timer application (e.g., an appearance of the application; (3) etc. As may be understood from this figure, a user of the interactive display device may not be able to perceive that the timer application 1510 is running on a separate computing device to the computing device (e.g., laptop) currently being displayed on the interactive display device). In this way, the system may be configured to provide the use of one or more applications that persist for the user (e.g., within the on-screen display) regardless of which connected device is the currently selected source, and regardless of whether any of the one or more applications are available on the currently selected source device.

In various embodiments, the timer application may persist, regardless of whether the timer application is being displayed, the currently active laptop is unplugged, etc.

In various embodiments, the system is configured to enable the user to interact with the timer. The user may, for example, select the pause and/or reset buttons. In response to selection, by the user, of an indicia associated with the timer application (e.g., the pause and/or reset button), the system may be configured to: (1) determine the input location; (2) determines that the input location comprises the on screen display; (3) determine which element of on screen display was selected; (4) route the input to the proper connected device based on the selected element (e.g., route the input to the connected device that is running the timer application. In this example, in response to the user selecting the stop button, the system may be configured to determine that the stop button was selected, route the input to the device running the timer application, and cause the connected device to perform an action in response to the input (i.e., stop the timer).

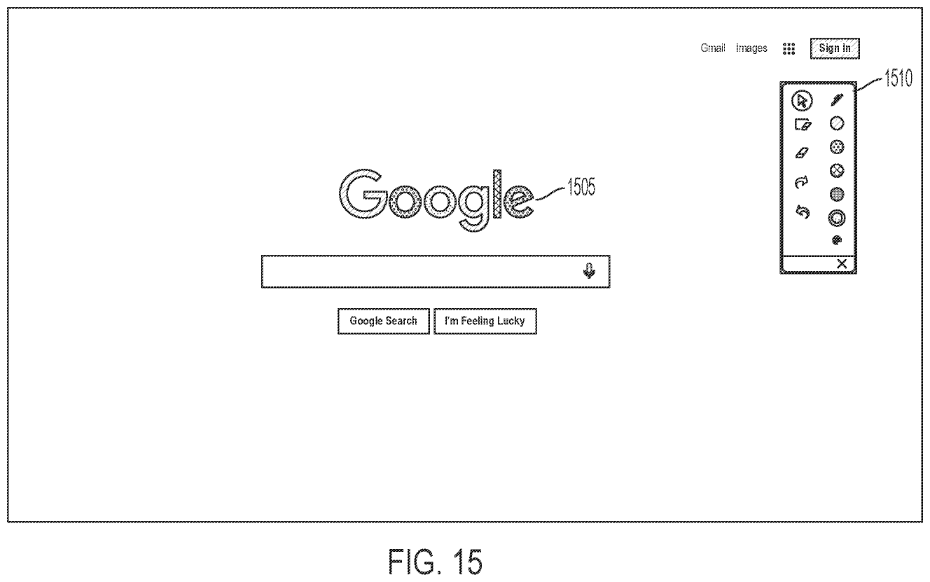

FIG. 15 depicts an exemplary screen display of an Interactive Display System 100 in which an Interactive Display Device 110 is currently displaying incoming images 1505 via a suitable video input from a first computing device. As may be understood from FIG. 15, the Interactive Display Device 110 is currently displaying the desktop from a computing device (e.g., laptop) that is currently accessing an internet browser. As shown in this figure, the Interactive Display Device 110 is also displaying an annotation application 1510 over the search engine. As may be understood in light of this disclosure, the Interactive Display System 100, in this example, is displaying the Annotation Application 1510 as part of the interactive display device's on-screen display, which is superimposed over the incoming images from the connected laptop (e.g., windows computer).

In particular embodiments, the Annotation Application 1510 is currently running on a second connected computing device (e.g., Connected Computing Device B 112B, the Interactive Display Controller Device 120, and/or a computing device integrated into the Interactive Display Device 110 or serving as a peripheral and/or console computing device to the interactive display device). In this example, the Interactive Display System 100 is receiving data associated with the annotation application (e.g., user annotation inputs) via a USB relay that is coupled to both the second connected computing device and a One or More Interactive Display Controller Processors producing the on-screen display on behalf of the Interactive Display Device 110. In various embodiments, the system is configured to store one or more user annotations on any suitable device (e.g., on the first connected computing device, on the second connected computing device, locally on the interactive display device, etc.). In various embodiments, the system is configured to store annotation data in any suitable location described herein (e.g., a particular one of the One or More Connected Computing Devices 112, etc.)

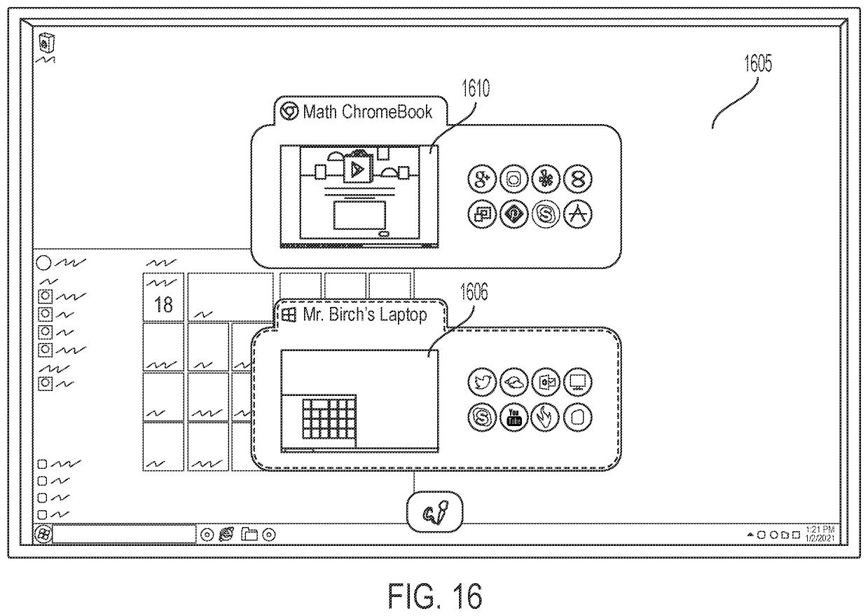

FIG. 16 depicts an exemplary screen display from an Interactive Display Device 110 displaying incoming images (e.g., via a suitable video input) from a first computing device (e.g., Mr. Birch's Laptop 1605). FIG. 16 further depicts a live (e.g., substantially live) preview 1610 of a second connected computing device (e.g., Math Chromebook). As may be understood in light of this disclosure, the live preview is received via the USB relay (e.g., rather than a particular video connection such as HDMI, as the first computing device is the currently selected video source) and generated within an on-screen disapply for the interactive display device. In the embodiment shown in this figure, a substantially live preview 1606 is also shown of the currently active video input (e.g., Mr. Birch's laptop). In particular embodiments, the substantially live preview 1606 of the currently active video input may also be generated within the on-screen display via data received from one or more USB relays between the first computing device and the interactive display device.

### User Experience

In a particular embodiment, the system is configured to configure one or more interfaces within the on-screen display based at least in part on an identified connected computing device. For example, a particular user of an interactive display device may provide one or more preferences (e.g., interface preferences), which may for example affect how the on-screen display displays certain user interfaces, menus, settings, etc. In particular embodiments, the system is configured to generate and/or modify the on-screen display in response to determining that a particular computing device has been connected to the interactive display. In such embodiments, the system may be configured to store and associate user settings data in association with a device ID for a particular computing device. In response to determining that a user has connected their user device to the interactive display, the system may be configured to retrieve the user's device settings and apply them when generating the on-screen display. In this way, the system may be configured to apply a user's preferred settings in response to the user plugging their computer into the interactive display devices, rather than requiring the user to login to a user account, select their own settings, etc.

In particular other embodiments, the Interactive Display Device 110 is configured as a peripheral configured to provide at least some software functionality to a user, while integrating one or more software applications running on One or More Connected Computing Devices 112. In such embodiments, the system may be configured to push software and network security maintenance to the One or More Connected Computing Device 112 (e.g., by not including particular software or operating system functionality on the Interactive Display Device 110 that may require periodic security updates and other updates to resolve security and other potential issues). For example, in particular embodiments, the Interactive Display Device 110 may not be connected to a network (e.g., such as the internet), and may rely on at least one of the One or More Connected Computing Devices 110 to provide network connectivity to a user of the Interactive Display Device 110 (e.g., via a Connected Computing Device 112A). In this way, by providing computing functionality via One or More Connected Computing Devices 112 (e.g., at least two of the One or More Connected Computing Devices 112 simultaneously by tapping into the on-screen display of the Interactive Display Device 110)), a user of the Interactive Display Device 110 may experience the Interactive Display Device 110 as a fully functioning computing device, despite the Interactive Display Device being configured as a peripheral.

In such embodiments, the One or More Computing Devices 112 are configured to provide external computing functionality to the Interactive Display Device 100 by providing one or more pieces of data for integration into a menu interface on the Interactive Display Device 110. As may be understood in light of the above, the one or more pieces of data may include, for example: (1) available software on the One or More Connected Computing Devices 112; (2) one or more substantially current views of a video output from each of the One or More Connected Computing Devices 112; (3) a display of at least a portion of a video output (e.g., a substantially current view) of at least one of the One or More Connected Computing Devices 112); and/or (4) any other suitable data (including video data, etc.) from the One or More Connected Computing Devices 112. In a particular example, a software application (e.g., Microsoft Word) may be available on a particular Connected Computing Device 112A. In particular embodiments, the Interactive Display Device 110 is configured: (1) to receive application data including the availability of Microsoft Word on the Connected Computing Device 112A; (2) modify the on-screen display of the Interactive Display Device 110 to include an icon or other indicia representing the software application; (3) receive an input from the user selecting the icon for Microsoft Word; (4) responsive to the selection of the icon, transmit event information to the Connected Computing Device 112A (e.g., via the USB relay) to launch Microsoft Word; and (5) select a source device for the Interactive Display Device 110 as the Connected Computing Device 112A. As may be understood from this disclosure, the system may be configured to integrate a plurality of available software applications from the different devices of the One or More Connected Computing Devices 112 into the on-screen display for selection by a user of the Interactive Display Device 110.

In particular embodiments, the system is configured to transmit any suitable data via any suitable UBS Relay described herein. For example, in a typical peripheral display system, the system may provide a video connection and a USB connection between an interactive display device and a connected device. In various embodiments, the video connection (e.g., HDMI) may be configured to transmit video data from the connected device to the interactive display. Additionally, the USB connection may be configured to provide input data from the interactive display device (e.g., from a touch input device on the interactive display deice) to the connected device. The introduction of the USB Relay, however, may enable the transmission of one or more additional types of data between the connected device and the interactive display device.

For example, the system may be configured to integrate and interface with one or more additional connected devices such as: (1) one or more oscilloscopes; (2) one or more data acquisition tools; (3) one or more musical instruments; (4) one or more computer numerical control (CNC) machines; (5) one or more imaging devices; and/or (6) any other suitable connected device which may, for example, include USB or other data connectivity via which the Interactive Display Device 110 can send and receive data. For example, the Interactive Display Device 110 may be configured to provide input data via an input device, while also receiving data from the connected device via the USB Relay.

In a particular example, a connected musical instrument (e.g., keyboard) may be configured to transmit midi data or other suitable data to the Interactive Display device 110. The Interactive Display Device 110 may then be configured to transmit any suitable data to the instrument (e.g., setting data, etc.).

In another example, the Interactive Display Device 110 (e.g., in a classroom setting) may be configured to serve as centralized hub for classroom activities. In a classroom utilizing a plurality of oscilloscopes for experimentation in small groups, each of the oscilloscopes may be connected to the Interactive Display Device 110 via a respective USB relay. In such an example, the Interactive Display Device 110 may be configured to receive data (e.g., oscilloscope data) from each of the connected oscilloscopes, and present combined oscilloscope data on the Interactive Display Device 110. In various embodiments, the Interactive Display Device 110 may be configured to utilize native software to interpret and display the combined data. In still other embodiments the Interactive Display Device 110 may be configured to transmit the oscilloscope data to another Connected Computing Device 112A to interpret and generate a display of the combined data before transferring the visual representation of the combined data back to the Interactive Display Device 110 for display. In particular embodiments, the Interactive Display Device may be configured to continuously received data from the one or more connected devices. In still other embodiments, the Interactive Display Deice 110 may receive periodic sampling of data from each of the one or more connected devices.

### CONCLUSION

Many modifications and other embodiments of the invention will come to mind to one skilled in the art to which this invention pertains having the benefit of the teachings presented in the foregoing descriptions and the associated drawings. While this specification contains many specific embodiment details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. For example, particular embodiments referring to one or more interactive display devices may include a single interactive display device, while still other embodiments referring to an interactive display device may include a plurality of interactive display devices.

Similarly, while operations are depicted in the drawings in a particular order, this should not be understood as requiring that such operations be performed in the particular order shown or in sequential order, or that all illustrated operations be performed, to achieve desirable results. Additionally, while some steps may be described as occurring in response to (e.g., or at least partially in response to) particular other steps, it should be understood that, in other embodiments, such steps may occur independent of (e.g., or coincident with) one another. In certain circumstances, multitasking and parallel processing may be advantageous. Moreover, the separation of various system components in the embodiments described above should not be understood as requiring such separation in all embodiments, and it should be understood that the described program components and systems may be generally integrated together in a single software product or packaged into multiple software products.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. An interactive display system for causing an interactive display device to display one or more pieces of data received from one or more connected computing devices, the interactive display system comprising:
a display device controller configured to be operatively coupled to the interactive display device and each of the one or more connected computing devices, the display device controller comprising one or more display device controller processors, wherein:
the one or more display device controller processors are configured as a first USB host device; and
the display device controller is configured for:
receiving, from a first connected computing device of the one or more connected computing devices, the one or more pieces of data, wherein the first connected computing device is configured as a second USB host device;
receiving the one or more pieces of data from the first connected computing device via a communications channel between the first USB host device and the second USB host device;
generating, by the one or more display device controller processors, an on-screen display based at least in part on the one or more pieces of data;
causing, by the one or more display device controller processors, the interactive display device to display one or more incoming images from a second connected computing device of the one or more connected computing devices; and
causing, by the one or more display device controller processors, the interactive display device to display the on-screen display along with the one or more incoming images from the second connected computing device.

2. The interactive display system of claim 1, wherein the interactive display device comprises the display device controller.

3. The interactive display system of claim 1, wherein:
the one or more pieces of data comprise a substantially current preview of a video output from the first connected computing device; and
generating, by the one or more display device controller processors, the on-screen display based at least in part on the one or more pieces of data comprises generating the on-screen display to include the substantially current preview of the video output from the first connected computing device.

4. The interactive display system of claim 1, wherein:
the one or more pieces of data comprise software data associated with a piece of software currently running on the first connected computing device; and
generating, by the one or more display device controller processors, the on-screen display based at least in part on the one or more pieces of data comprises generating the on-screen display to include the piece of software.

5. The interactive display system of claim 4, wherein the piece of software is selected from the group consisting of:
a timer application; and
an annotation application.

6. The interactive display system of claim 1, wherein:
the display controller further comprises one or more USB relays, each of the one or more USB Relays being configured as a USB device to both the one or more display device controller processors and each of the one or more connected computing devices; and
the interactive display system is configured for receiving, via the communications channel, the one or more pieces of data at the one or more USB relays configured as the USB device to the first USB host device from the second USB host device.

7. The interactive display system of claim 1, wherein:
the display controller is configured to operatively couple to the second connected computing device via a first video connection; and
causing, by the one or more display device controller processors, the interactive display device to display the one or more incoming images from the second connected computing device comprises selecting, by the one or more display device controller processors, the first video connection as a video input for the interactive display device.

8. The interactive display system of claim 1, wherein:
the integrated display system is further configured for identifying, based at least in part on the one or more pieces of data, a device ID associated with the first connected computing device; and
generating, by the one or more display device controller processors, the on-screen display based at least in part on the one or more pieces of data comprises:
retrieving one or more user preferences associated with the device ID; and
generating the on-screen display based at least in part on the one or more user preferences.

9. The interactive display system of claim 8, wherein generating the on-screen display based at least in part on the one or more user preferences comprises determining one or more contents of at least one user interface displayed within the on-screen display based at least in part on the one or more user preferences.

10. A computer-implemented data processing method of modifying an on-screen display of an interactive display device that is operatively coupled to a display controller to include one or more first images from a first connected computing device while the interactive display device is displaying one or more incoming images from a second connected computing device, the second connected computing device being the currently selected video source for the interactive display device, the method comprising:
configuring, by one or more computer processors, the first connected computing device as a first USB host device;
configuring, by the one or more computer processors, a display controller device as a second USB host device;
providing, by the one or more computer processors, a data communication channel between the first USB host device and the second USB host device;
receiving, by the one or more computer processors, via a data communication channel between the first USB host device and the second USB host device, one or more pieces of data from the first connected computing device;
generating, by the one or more computer processors, an on-screen display based at least in part on the one or more pieces of data;
causing, by the one or more computer processors, the interactive display device to display the one or more incoming images from the second connected computing device; and
causing, by the one or more computer processors, the interactive display device to superimpose the generated on-screen display over at least a portion of the one or more incoming images from the second connected computing device.

11. The computer-implemented data processing method of claim 10, wherein:
the one or more pieces of data comprise software data associated with a piece of software currently running on the first connected computing device; and
generating, by the one or more computer processors, the on-screen display based at least in part on the one or more pieces of data comprises generating the on-screen display to include a visual representation of the piece of software.

12. The computer-implemented data processing method of claim 11, the method further comprising:
receiving, by the one or more computer processors, an input on the interactive display device;
determining, by the one or more computer processors, a location of the input;
determining that the input location comprises the visual representation of the piece of software on the on-screen display; and
in response to determining that the input location comprises the visual representation of the piece of software on the on-screen display, transmitting the input location to the first connected computing device via the data communication channel.

13. The computer-implemented data processing method of claim 12, wherein the piece of software is selected from the group consisting of:
a timer application; and
an annotation application.

14. The computer-implemented data processing method of claim 10, wherein:
the method further comprises determining, based at least in part on the one or more pieces of data, a device ID associated with the first connected computing device; and
generating, by the one or more computer processors, the on-screen display based at least in part on the one or more pieces of data comprises:
retrieving one or more user preferences associated with the device ID; and
generating the on-screen display based at least in part on the one or more user preferences.

15. The computer-implemented data processing method of claim 14, wherein generating the on-screen display based at least in part on the one or more user preferences comprises determining and applying at least one device setting for the interactive display device based at least in part on the one or more user preferences.

16. The computer-implemented data processing method of claim 10, wherein:
the one or more pieces of data comprise a substantially current preview of a video output from the first connected computing device; and
generating, by the one or more display device processors, the on-screen display based at least in part on the one or more pieces of data comprises generating the on-screen display to include the substantially current preview of the video output from the first connected computing device.

17. The computer-implemented data processing method of claim 16, wherein the method further comprises:
configuring, by one or more computer processors, the second connected computing device as a third USB host device;
providing, by one or more computer processors, a second data communication channel between the second USB host device and the third USB host device;
determining, by one or more computer processors, that the one or more pieces of data include one or more pieces of data for the second connected computing device; and
in response to determining that the one or more pieces of data include the one or more pieces of data for the second connected computing device, transmitting, by one or more processors, the one or more pieces of data for the second connected computing device from the display controller to the second connected computing device via the second data communication channel.

18. The computer-implemented data processing method of claim 10, wherein
providing the data communication channel between the first USB host device and the second USB host device comprises providing the data communication channel via a USB relay configured as a USB device to both the first USB host device and the second USB host device

19. An interactive display system for integrating one or more pieces of data received from one or more connected computing devices into an onscreen display of an interactive display device operatively coupled to each of the one or more connected computing devices, the interactive display system comprising:
one or more interactive display device processors;
one or more touch-enabled input devices; and
one or more USB relays, each of the one or more USB relays being operatively connected to the one or more interactive display device processors, wherein the one or more USB relays comprise a first USB relay, wherein:
a first connected computing device of the one or more connected computing devices is configured as a first USB host device;
the one or more interactive display device processors are configured as a second USB host device;
the first USB relay is configured as a USB device to the both the first USB host and the second USB host and configured to form a communications channel between the first connected computing device and the one or more interactive display device processors, wherein the interactive display system is configured for:
receiving, via the communications channel, one or more pieces of data at the first USB relay acting as the USB device to the first USB host from the first connected computing device; and
passing, via the communications channel, by the first USB relay acting as the USB device to the second USB host, the received one or more pieces of data from the first USB relay through to the one or more interactive display device processors;
generating, by the one or more interactive display device processors, an on-screen display based at least in part on the one or more pieces of data;
causing, by the one or more interactive display device processors, the interactive display device to display one or more incoming images from a second connected computing device of the one or more connected computing devices; and
causing, by the one or more interactive display device processors, the interactive display device to display the generated on-screen display along with the one or more incoming images from the second connected computing device.

20. The interactive display system of claim 19, wherein causing, by the one or more interactive display device processors, the interactive display device to display the one or more incoming images from the second connected computing device of the one or more connected computing devices comprises causing the interactive display device to select the second connected computing device as a video source for the interactive display device.
